(19) United States
(12) Patent Application Publication
(10) Pub. No.: US 2019/0279684 A1
(43) Pub. Date: Sep. 12, 2019

(54) IMAGE PROCESSING APPARATUS THAT GENERATES A STILL IMAGE FILE FROM A MOVING IMAGE FILE, IMAGE PROCESSING METHOD, AND STORAGE MEDIUM

(71) Applicant: CANON KABUSHIKI KAISHA, Tokyo (JP)

(72) Inventor: Toru Kobayashi, Tokyo (JP)

(21) Appl. No.: 16/290,777

(22) Filed: Mar. 1, 2019

(30) Foreign Application Priority Data
Mar. 6, 2018 (JP) 2018-040125

(51) Int. Cl. G11B 27/34; G11B 27/30; G11B 20/00

(52) U.S. Cl. CPC G11B 27/34; G11B 20/00007; G11B 27/3081

(57) ABSTRACT

An image processing apparatus for selecting a particular frame among a plurality of frames encoded by using inter-frame-coding in a moving image file; specifying one or more frames among the plurality of frames included in the moving image file, that is necessary for decoding the particular frame; and storing, in a still image file, the particular frame, the specified one or more frames and information indicating that the particular frame is to be displayed by decoding with the specified one or more frames.

### BACKGROUND OF THE INVENTION

### Field of the Invention

The present invention relates to an image processing apparatus that generates a still image file from a moving image file, an image processing method, and a storage medium.

### Description of the Related Art

The H.264/AVC format, the H.265/HEVC format, and the like have been proposed as moving image file standards. Additionally, the High Efficiency Image File Format (abbreviated as “HEIF” hereinafter) has been proposed as a still image file format (see ISO/IEC FDIS 23008-12, “Information technology—High efficiency coding and media delivery in heterogeneous environments—Part 12: Image File Format”). Compared to past still image file formats such as JPEG, HEIF has characteristics such as those described below. The HEIF file format is based on the ISO base media file format (abbreviated as “ISOBMFF” hereinafter) (see ISO/IEC 14496-12, “Information technology—Coding of audio-visual objects—Part 12: ISO base media file format”). A file in the HEIF format, i.e., an HEIF file, can store not just one but multiple still images. An HEIF file can also store data in a media format such as a moving image, audio, and the like. Furthermore, an HEIF file can also store still images compressed in a coding format for moving images, such as HEVC and H.264/AVC.

The frames constituting a moving image file are subjected to inter-frame coding and the like, and thus it is not necessarily easy to generate a quality still image file using a frame constituting a moving image file.

### SUMMARY OF THE INVENTION

The present disclosure has been made in consideration of the aforementioned issues, and realizes a technique through which a quality still image file can be generated from a moving image file.

In order to solve the aforementioned issues, one aspect of the present disclosure provides an image processing apparatus comprising: a selecting unit configured to select a particular frame among a plurality of frames encoded by using inter-frame-coding in a moving image file; a specifying unit configured to specify one or more frames among the plurality of frames included in the moving image file, that is necessary for decoding the particular frame; and a storing unit configured to store, in a still image file, the particular frame, the specified one or more frames and information indicating that the particular frame is to be displayed by decoding with the specified one or more frames.

Another aspect of the present disclosure provides, a control method of an image processing apparatus, the method comprising: selecting a particular frame among a plurality of frames encoded by using inter-frame-coding in a moving image file; specifying one or more frames among the plurality of frames included in the moving image file, that is necessary for decoding the particular frame; and storing, in a still image file, the particular frame, the specified one or more frames and information indicating that the particular frame is to be displayed by decoding with the specified one or more frames.

Further features of the present disclosure will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the present disclosure, and together with the description, serve to explain the principles of the present disclosure.

FIG. 1 is a diagram illustrating an HEIF file structure that stores a still image representing a single image or an image collection.

FIG. 2 is a diagram illustrating an HEIF file structure that stores a still image representing an image sequence.

FIG. 3 is a diagram illustrating an HEIF file structure that stores both a still image representing a single image or an image collection and a still image representing an image sequence.

FIG. 4 is a block diagram illustrating the configuration of an image processing apparatus according to a first embodiment.

FIG. 5 is a flowchart illustrating operations performed by the image processing apparatus according to the first embodiment.

FIG. 6 is a diagram illustrating an example of frame data and image sequence data.

FIG. 7 is a diagram illustrating an example of the structure of an edit list box.

FIG. 8 is a flowchart illustrating operations performed by an image processing apparatus according to a second embodiment.

FIG. 9 is a flowchart illustrating operations performed by an image processing apparatus according to a third embodiment.

FIG. 10 is a flowchart illustrating operations performed by an image processing apparatus according to a fourth embodiment.

FIGS. 11A and 11B are flowcharts illustrating operations performed by an image processing apparatus according to a fifth embodiment.

FIG. 12 is a flowchart illustrating operations performed by an image processing apparatus according to a sixth embodiment.

FIG. 13 is a flowchart illustrating operations performed by the image processing apparatus according to the sixth embodiment.

FIG. 14 is a flowchart illustrating operations performed by the image processing apparatus according to the sixth embodiment.

FIG. 15 is a diagram illustrating an example of a visual sample entry.

FIG. 16 is a flowchart illustrating operations performed by the image processing apparatus according to the sixth embodiment.

FIG. 17 is a flowchart illustrating operations performed by the image processing apparatus according to the sixth embodiment.

FIG. 18 is a flowchart illustrating operations performed by the image processing apparatus according to the sixth embodiment.

FIG. 19 is a diagram illustrating an example of an item property box.

FIG. 20 is a flowchart illustrating operations performed by the image processing apparatus according to the sixth embodiment.

### DESCRIPTION OF THE EMBODIMENTS

Hereinafter, embodiments of the present disclosure will be described with reference to the drawings. The present disclosure is not limited to the following embodiments, however.

### First Embodiment

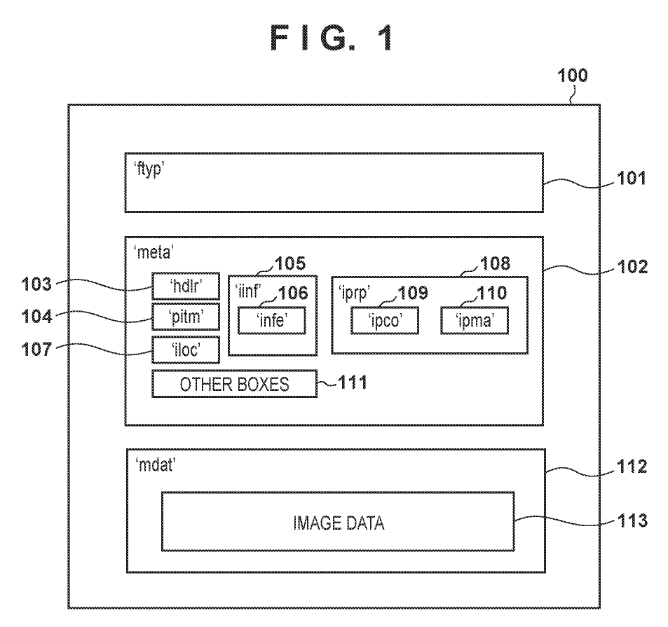

An image processing apparatus and image processing method according to a first embodiment will be described using FIGS. 1 to 7. Although the present embodiment will describe a case where a moving image file is a moving image file in the H.265/HEVC format as an example, the present disclosure is not limited thereto. Additionally, although the present embodiment will describe a case where a frame (compressed frame data) for obtaining a still image is stored in a file in the HEIF format (an HEIF file), the present disclosure is not limited thereto.

The HEIF file will be described first.

HEIF is based on ISOBMFF. ISOBMFF will thus be described briefly first.

In ISOBMFF, data is managed using a structure called a “box”.

The box is a data structure starting with a four-byte data length field and a four-byte data type field, which are followed by a data part of a given length. The structure of the data part is determined by the data type. The ISOBMFF specifications, HEIF specifications, and so on define several data types and data part structures thereof.

The box may contain another box as data. In other words, boxes can be nested. A box nested in the data part of a given box is called a “sub box”.

A box that is not a sub box of another box is called a “file level” box. A file level box is a box that can be accessed even when located at the start of the file.

Still image data stored in an HEIF file is broadly divided into two types.

The first type of still image data is called an image (image data) or an image collection (image collection data). An “image” is a still image that has no reference relationship at the time of encoding, i.e., a single still image. The “single still image” is encoded in a format that can be decoded independently. An “image collection” is a collection of a plurality of independent still images. The “plurality of independent still images” is a collection of still images, each of which is encoded in a format that can be independently decoded, and that have no reference relationship at the time of encoding.

The second type of still image data is called an image sequence (image sequence data). An “image sequence” is a collection of a plurality of still images having a dependency relationship. A “plurality of still images having a dependency relationship” is a collection of still images having a reference relationship at the time of encoding, such as a collection of still images obtained through inter-frame-coding. Thus to decode still image data belonging to an image sequence, it is necessary to also decode the other still images that were referred to when the still image to be decoded was encoded.

An example of the HEIF file structure that stores a still image representing a single image or an image collection will be described with reference to FIG. 1. FIG. 1 is a diagram illustrating an HEIF file structure 100 that stores a still image representing a single image or an image collection.

The file structure 100 includes a file type box 101 having a data type of “ftyp”. Information pertaining to file compatibility is stored in the file type box 101.

The file structure 100 further includes a metadata box 102 having a data type of “meta”. The metadata box 102 includes various sub boxes. Data pertaining to the still image is stored in the metadata box 102.

The metadata box 102 includes a handler box 103 having a data type of “hdlr”. The handler box 103 stores information indicating the type of the data managed by the metadata box 102. If the type of the data managed by the metadata box 102 is a still image corresponding to a single image or an image collection, a handler type (handler type) of the handler box 103 is “pict”.

The metadata box 102 further includes a primary item box 104 having a data type of “pitm”. The primary item box 104 stores an item ID indicating a primary image. In an HEIF file, images, metadata, and the like are managed in 10181444US01/P219-0104US units called “items”. An item ID unique within the file is assigned to each item.

The metadata box 102 further includes an item information box 105 having a data type of “iinf”. The item information box 105 is a box for storing an item information entry 106.

The item information box 105 includes the item information entry 106, which has a data type of “infe”. The item ID, item type, and the like of the corresponding item are stored in the item information entry 106.

The metadata box 102 further includes an item location box 107 having a data type of “iloc”. The item location box 107 stores information indicating the location (offset) of the item in the file, information indicating the length (data length) of the item, and so on.

The metadata box 102 further includes an item properties box 108 having a data type of “iprp”. The item properties box 108 is a box for storing an item properties container box 109 and an item properties association box 110.

The item properties box 108 includes the item properties container box 109, which has a data type of “ipco”. The item properties container box 109 stores individual property data.

The item properties box 108 further includes the item properties association box 110 having a data type of “ipma”. The item properties association box 110 stores associations between each item and its properties.

Note that the metadata box 102 further includes boxes aside from the above-described boxes, i.e., other boxes 111, but detailed descriptions thereof will be skipped here.

The file structure 100 further includes a media data box 112 having a data type of “mdat”. The media data box 112 stores still image data representing a single image or an image collection, i.e., image data 113.

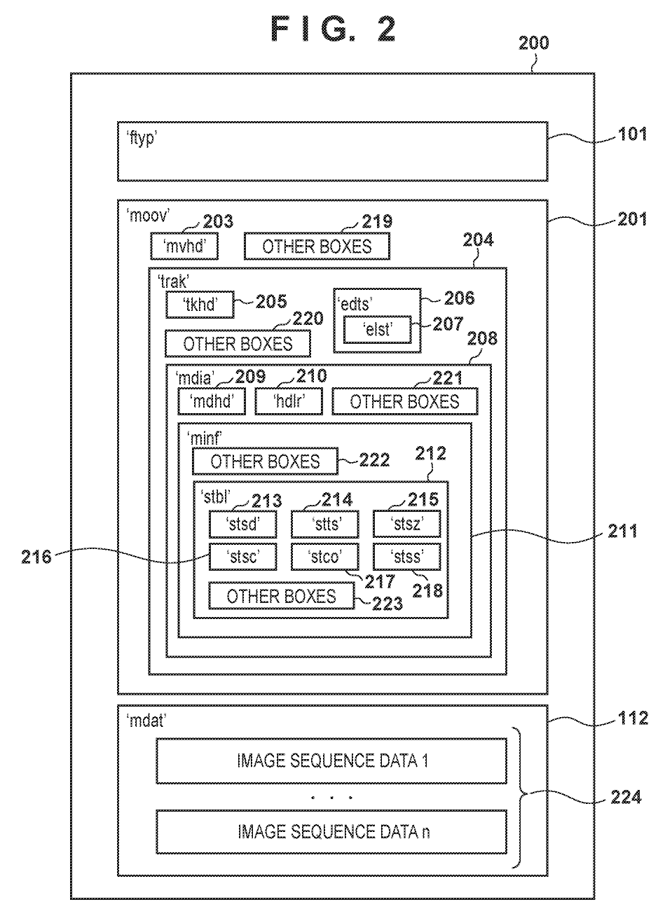

An example of the HEIF file structure that stores a still image representing an image sequence will be described with reference to FIG. 2. FIG. 2 is a diagram illustrating an HEIF file structure 200 that stores a still image representing an image sequence.

The file structure 200 includes a file type box 101 having a data type of “ftyp”. Information pertaining to file compatibility is stored in the file type box 101.

The file structure 200 further includes a movie box 201 having a data type of “moov”. The movie box 201 includes various sub boxes. The movie box 201 stores data pertaining to still images in the image sequence. If media in a format aside from still image is present, data pertaining to data in that format is also stored.

The movie box 201 includes a movie header box 203 having a data type of “mvhd”. The movie header box 203 stores information pertaining to an overall movie. “Information pertaining to an overall movie” is the creation date/time of the movie, the timescale of the movie, the length of the movie (playback display time), and so on.

The movie box 201 further includes a track box 204 having a data type of “trak”. The track box 204 is a box for storing boxes pertaining to a track, such as the following. As described above, data in media formats such as moving images and audio can be stored in an HEIF file, in addition to still images. If data in a media format such as a moving image or audio is also present in an HEIF file in which still images of an image sequence are stored, each instance of data is handled as different tracks/media. Accordingly, the movie box 201 can include a plurality of track boxes 204 and sub boxes thereof.

The track box 204 includes a track header box 205 having a data type of “tkhd”. The track header box 205 stores information pertaining to an overall track. “Information pertaining to an overall track” is the creation date/time of the track, a track ID identifying the track, the length of the track (playback display time), a display coordinate transformation matrix, and so on.

The track box 204 includes an edit box 206 having a data type of “edts”. The edit box 206 is a box for storing an edit list box 207.

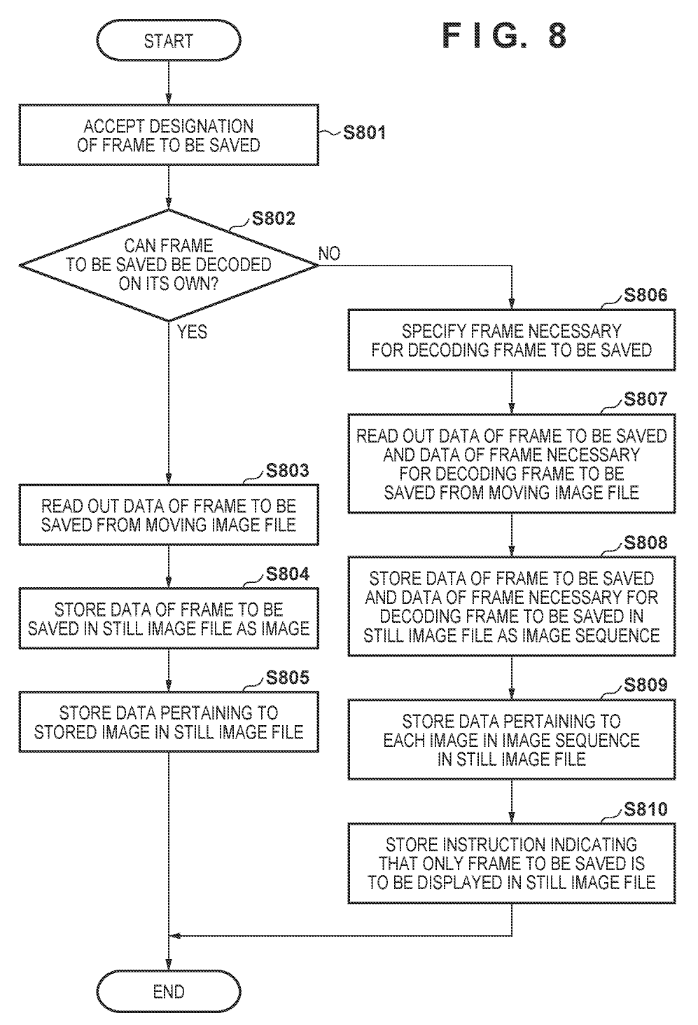

The edit box 206 includes the edit list box 207, which has a data type of “elst”. The edit list box 207 stores information associating a time corresponding to an image (frame) to be displayed with a track time (display time). The edit list box 207 will be described in detail later using FIG. 7.

The track box 204 includes a media box 208 having a data type of “mdia”. The media box 208 is a box for storing boxes pertaining to media, such as those described below.

The media box 208 includes a media header box 209 having a data type of “mdhd”. The media header box 209 stores information pertaining to the overall media. “Information pertaining to the overall media” is the media creation date/time, the media timescale, the media length (time), and so on.

The media box 208 includes a handler box 210 having a data type of “hdlr”. The handler box 210 stores information indicating the type of the media. If the media type is a still image in an image sequence, the handler type of the handler box 210 is “pict”.

The media box 208 includes a media information box 211 having a data type of “minf”. The media information box 211 is a box for storing boxes pertaining to media, such as those described below.

The media information box 211 includes a sample table box 212 having a data type of “stbl”. The sample table box 212 is a box for storing boxes pertaining to media samples, such as those described below.

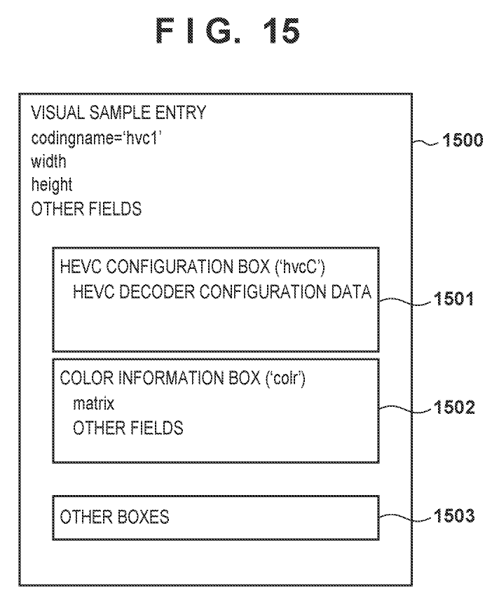

The sample table box 212 includes a sample description box 213 having a data type of “stsd”. Initialization information used at the time of decoding, called a “sample entry”, is stored in the sample description box 213 as table information. If the handler type of the handler box 210 is “pict”, the sample entry has the structure of a visual sample entry 1500 (see FIG. 15). The visual sample entry 1500 will be described later using FIG. 15.

The sample table box 212 includes a decode time-sample box 214 having a data type of “stts”. The decode time-sample box 214 stores information pertaining to an association between a decode time and a sample number.

The sample table box 212 further includes a sample size box 215 having a data type of “stsz”. The sample size box 215 stores the data length of each sample.

The sample table box 212 further includes a sample-chunk box 216 having a data type of “stsc”. The sample-chunk box 216 stores information associating a sample number with a chunk. A “chunk” is a collection of sample data stored in consecutive regions within a file.

The sample table box 212 further includes a chunk offset box 217 having a data type of “stco”. The chunk offset box 217 stores information indicating the location (offset) of each chunk within the file.

The sample table box 212 further includes a sync sample box 218 having a data type of “stss”. The sync sample box 218 stores a sample number of a sync sample. A “sync sample” is a sample which can be decoded using that sample data alone, and which, when decoding sample data following the sample data in question, does not require the sample data located before the sample data in question. If the video coding format is HEVC, the IDR frame corresponds to the sync sample. Note that all frames are IDR frames if the sync sample box 218 is not present.

Boxes 219 to 223 are also present in each box, in addition to those described above, but these will not be described here.

The file structure 200 further includes the media data box 112 having a data type of “mdat”. The media data box 112 stores still image data of an image sequence, i.e., image sequence data 224.

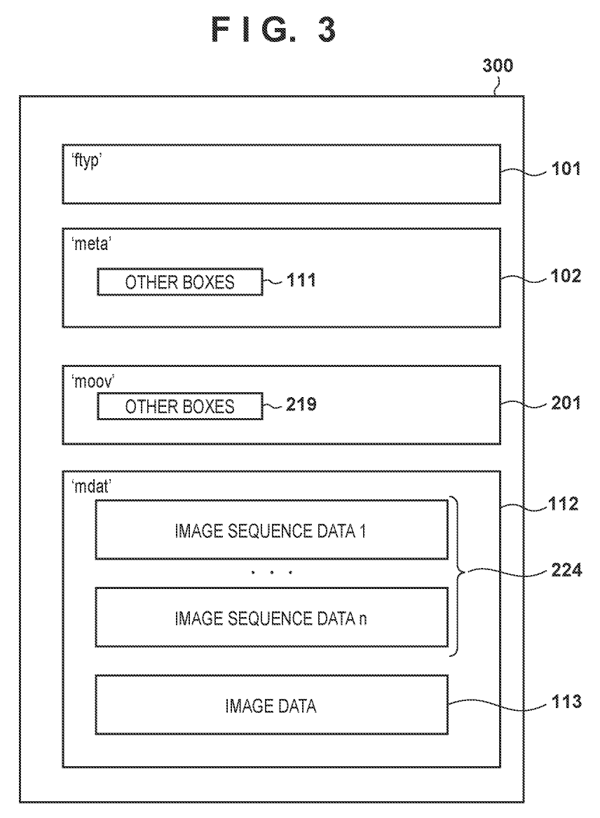

An example of an HEIF file structure that stores both a still image representing a single image or an image collection and a still image representing an image sequence will be described next using FIG. 3. FIG. 3 is a diagram illustrating an HEIF file structure 300 that stores both a still image representing a single image or an image collection and a still image representing an image sequence.

The file structure 300 includes the file type box 101 having a data type of “ftyp”. Information pertaining to file compatibility is stored in the file type box 101.

The file structure 300 further includes the metadata box 102 having a data type of “meta”. The metadata box 102 illustrated in FIG. 3 is the same as the metadata box 102 described above with reference to FIG. 1. The metadata box 102 includes various sub boxes that hold information pertaining to the still image representing a single image or an image collection.

The file structure 300 further includes the movie box 201 having a data type of “moov”. The movie box 201 illustrated in FIG. 3 is the same as the movie box 201 described above with reference to FIG. 2. The movie box 201 includes various sub boxes that hold information pertaining to the still image representing an image sequence.

The file structure 300 further includes the media data box 112 having a data type of “mdat”. The media data box 112 stores still image data representing an image sequence, i.e., the image sequence data 224, and still image data representing a single image or an image collection, i.e., the image data 113.

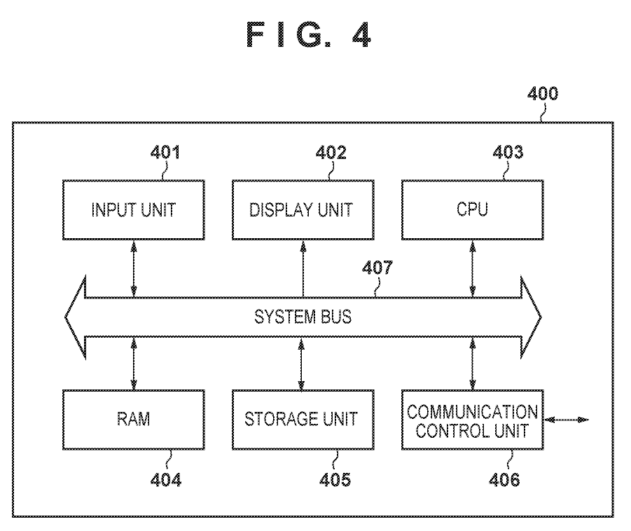

FIG. 4 is a block diagram illustrating the configuration of the image processing apparatus according to the present embodiment.

An image processing apparatus 400 according to the present embodiment includes an input unit 401, a display unit 402, a CPU (Central Processing Unit) 403, RAM (Random Access Memory) 404, and a storage unit 405. The image processing apparatus 400 further includes a communication control unit 406 and a system bus 407.

The input unit 401 includes a keyboard, a pointing device, and the like, for example. The input unit 401 accepts control instructions through buttons or the like displayed in the display unit 402. A mouse, a trackball, a tablet, and the like can be given as examples of pointing devices.

The display unit 402 is constituted by, for example, a CRT (Cathode Ray Tube) display, an LCD (Liquid Crystal Display), or the like. The display unit 402 displays a GUI (Graphical User Interface) screen, images, and the like. The display unit 402 may include a processing device called a GPU (Graphics Processing Unit).

The CPU 403 controls the image processing apparatus 400 as a whole.

The RAM 404 provides the CPU 403 with a work area necessary for the image processing apparatus 400 to carry out various types of processes. Additionally, control programs, a moving image processing program, and the like stored in the storage unit 405 are executed by the CPU 403 after first being read out to the RAM 404.

The storage unit 405 stores control programs, the moving image processing program, moving image files, still image files, and the like required for various types of processes carried out by the image processing apparatus 400. Note that the moving image processing program will be described in detail later.

The communication control unit 406 includes a communication interface such as USB (Universal Serial Bus), Ethernet, or the like, for example. The image processing apparatus 400 can communicate with external devices via the communication control unit 406. The communication control unit 406 may make a wired connection using a communication cable, or may make a wireless connection without using a communication cable.

These function blocks are connected by the system bus 407.

Although the present embodiment describes a case where the moving image processing program is stored in the storage unit 405 as an example, the configuration is not limited thereto. For example, the moving image processing program may be stored in an external storage unit connected to the communication control unit 406, or the moving image processing program may be stored on a network.

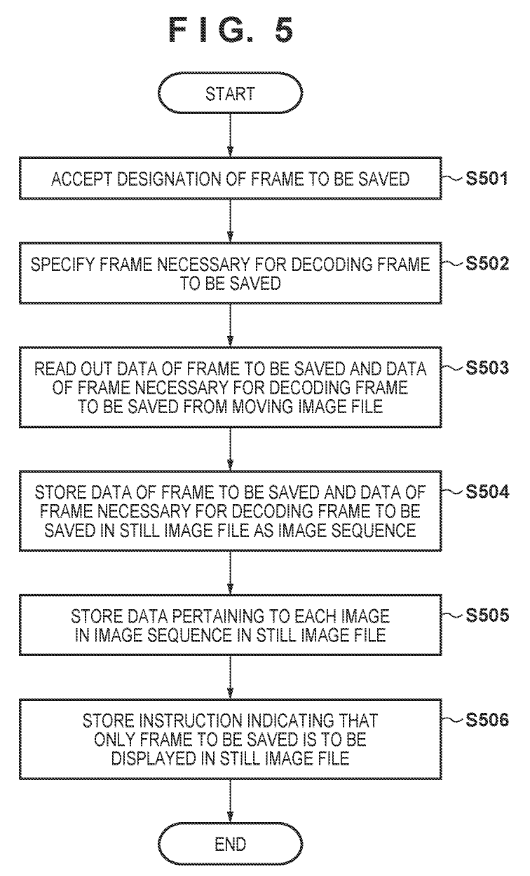

FIG. 5 is a flowchart illustrating operations performed by the image processing apparatus according to the present embodiment. FIG. 5 illustrates a sequence carried out when recording a still image. The processing illustrated in FIG. 5 is executed by the CPU 403.

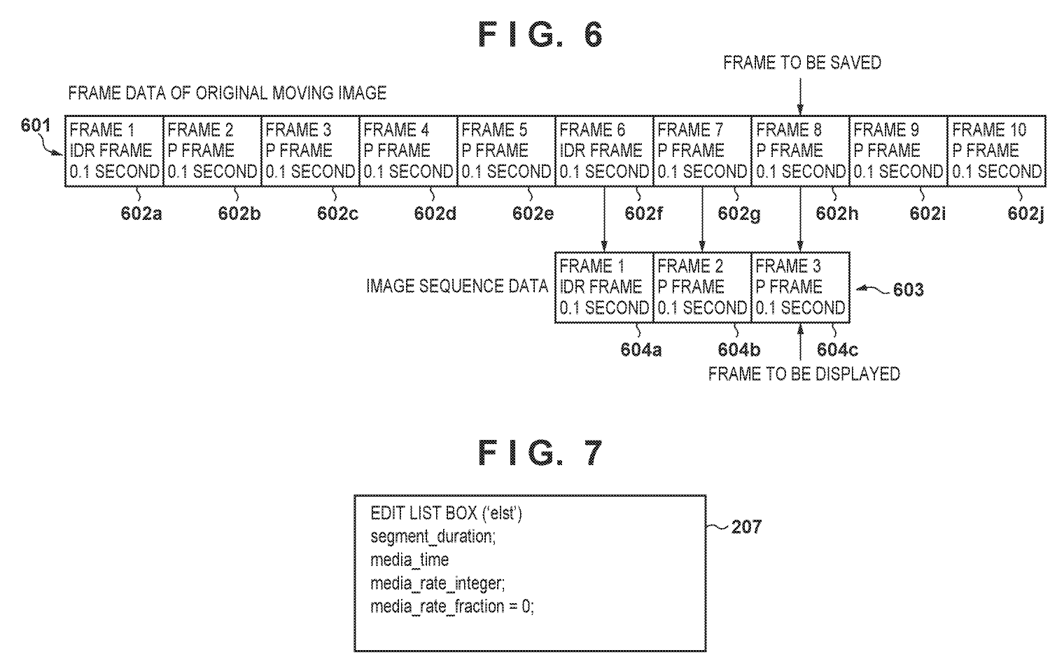

As an example, the present embodiment describes a moving image file having frame data 601 such as that illustrated in FIG. 6. FIG. 6 is a diagram illustrating an example of the frame data and image sequence data. The frame data 601, i.e., the frame data of an original image, is constituted by ten frames 602a to 602j, for example. Reference sign 602 will be used when describing the frames in general, whereas reference signs 602a to 602j will be used when describing the individual frames. The display time of each of the ten frames 602 constituting the frame data 601 is 0.1 seconds, for example. The frame 602a is the first frame of the ten frames constituting the frame data 601, i.e., a frame with a frame number of 1. The frame 602b is the second frame of the ten frames constituting the frame data 601, i.e., a frame with a frame number of 2. The frame 602c is the third frame of the ten frames constituting the frame data 601, i.e., a frame with a frame number of 3. The frame 602d is the fourth frame of the ten frames constituting the frame data 601, i.e., a frame with a frame number of 4. The frame 602e is the fifth frame of the ten frames constituting the frame data 601, i.e., a frame with a frame number of 5. The frame 602f is the sixth frame of the ten frames constituting the frame data 601, i.e., a frame with a frame number of 6. The frame 602g is the seventh frame of the ten frames constituting the frame data 601, i.e., a frame with a frame number of 7. The frame 602h is the eighth frame of the ten frames constituting the frame data 601, i.e., a frame with a frame number of 8. The frame 602i is the ninth frame of the ten frames constituting the frame data 601, i.e., a frame with a frame number of 9. The frame 602j is the tenth frame of the ten frames constituting the frame data 601, i.e., a frame with a frame number of 10.

The frame 602a having a frame number of 1 and the frame 602f having a frame number of 6 are IDR frames. As such, this moving image file includes the sync sample box 218. The frame number 1 and the frame number 6 are held in the sync sample box 218. Of the ten frames 602 included in frame data 601, the frames aside from the frames 602a and 602f, that is, the frames 602b to 602e and 602g to 602j, are P frames. The P frames, that is, the frames 602b to 602e and 602g to 602j, are frames that have been subjected to inter-frame coding.

In step S501, the designation of a frame to be saved (a frame to be displayed) is accepted in response to a user's operation. The CPU 403 acquires information specifying the frame to be saved. The information specifying the frame to be saved is the frame number, for example. A case where the frame 602h, having a frame number of 8, is the frame to be saved will be described as an example here, but the frame to be saved is not limited thereto. The process then moves to step S502.

In step S502, the CPU 403 specifies the frames necessary for decoding the frame to be saved automatically. As described above, to decode frames that have been subjected to inter-frame coding, the data of the frames subjected to inter-frame coding is insufficient. To decode a frame that has been subjected to inter-frame coding, the data from the nearest IDR frame before the frame in question to the frame immediately before the frame in question is necessary.

In ISOBMFF, the frame numbers of the IDR frames are managed by the sync sample box 218 within the sample table box 212. As such, of the frame numbers of the IDR frames managed by the sync sample box 218, the frame number meeting the conditions described below corresponds to the frame number of the nearest IDR frame before the frame to be saved. That is, the frame having a frame number that is the highest of the frame numbers of the IDR frames managed by the sync sample box 218, but that is lower than the frame number of the frame to be saved, is the nearest IDR frame before the frame to be saved. The frames necessary for decoding the designated frame to be saved are therefore the frames from the nearest IDR frame before the frame to be saved to the frame immediately before the frame to be saved.

In the example illustrated in FIG. 6, of the frame numbers of the IDR frames managed by the sync sample box 218, frame numbers 1 and 6 are lower than the frame number of the frame to be saved, which is 8. Of the frame 602a, which is frame number 1, and the frame 602f, which is frame number 6, the frame 602 with the highest frame number is the frame 602f, which is frame number 6. Thus in the example illustrated in FIG. 6, the frame number of the nearest IDR frame before the frame to be saved is frame number 6. Accordingly, the frame 602f, which is frame number 6, and the frame 602g, which is frame number 7, are the frames 602 necessary for decoding the frame 602h, which is the designated frame to be saved. The process then moves to step S503.

In step S503, the CPU 403 reads out the data of the designated frame to be saved and the data of the frames specified in step S502 from the moving image file. In other words, the CPU 403 reads out the data of the designated frame to be saved and the data of the frames necessary for decoding the designated frame to be saved from the moving image file. Then, the CPU 403 holds the data read out from the moving image file in the RAM 404. Here, a case where the data of the frame 602f, which is frame number 6, the data of the frame 602g, which is frame number 7, and the data of the frame 602h, which is frame number 8, are read out is described as an example, but the read-out data is not limited thereto. The process then moves to step S504.

In step S504, the CPU 403 stores data such as that described below in the media data box 112 of the HEIF file. The CPU 403 stores the data of the frame to be saved, which was read out in step S503, and the data of the frames necessary for decoding the data of the frame to be saved, which was read out in step S503, in the media data box 112 of the HEIF file. This data is stored in the media data box 112 of the HEIF file as the image sequence data 224. Note that the HEIF file is stored in the storage unit 405. As illustrated in FIG. 6, image sequence data 603 stored in the media data box 112 of the HEIF file is constituted by, for example, three frames 604a to 604c. Reference sign 604 will be used when describing the frames in general, whereas reference signs 604a to 604c will be used when describing the individual frames. The frame 604a is the first frame of the three frames 604 constituting the image sequence data 603, i.e., a frame with a frame number of 1. The frame 604b is the second frame of the three frames 604 constituting the image sequence data 603, i.e., a frame with a frame number of 2. The frame 604c is the third frame of the three frames 604 constituting the image sequence data 603, i.e., a frame with a frame number of 3. Although a case in which the HEIF file is stored in the storage unit 405 will be described here as an example, the configuration is not limited thereto. For example, the HEIF file may be stored in storage unit located outside the image processing apparatus 400. In this case, the data stored in the HEIF file held in the storage unit located outside the image processing apparatus 400 is transmitted via the communication control unit 406. The process then moves to step S505.

In step S505, the CPU 403 stores the data pertaining to the respective images constituting the image sequence data 603 stored in step S504 in sub boxes within the movie box 201 of the HEIF file. The process then moves to step S506.

In step S506, the CPU 403 carries out the following processing. The CPU 403 stores, in the HEIF file, an instruction for displaying only the frame 604c, which is the frame to be saved, from among the frames 604a to 604c stored in the media data box 112 of the HEIF file in step S504. This instruction for displaying only the frame 604c, which is the frame to be saved, is stored in the edit list box 207.

FIG. 7 is a diagram illustrating an example of the structure of the edit list box. As described above, the edit list box 207 stores information associating a time corresponding to the image (frame) to be displayed with a track time (display time). Specifically, the edit list box 207 can store segment_duration, media_time, media_rate_integer, and media_rate_fraction. In ISOBMFF, setting 0 for the segment_duration and a positive value for the media_time makes it possible to instruct the data from a time corresponding to media time to be played back and displayed from a playback time of 0. Additionally, in ISOBMFF, the following instructions can be made by setting 0 for the media_rate_integer and the media_rate_fraction. That is, rather than playing back and displaying the data in sequence, an instruction can be made to continuously display only the data of the time corresponding to media_time. In other words, in ISOBMFF, it is possible to display only the data of the time corresponding to media_time as a still image by setting 0 for the media_rate_integer and the media_rate_fraction. Although a case where the frame 604c, having a frame number of 3, is displayed from among the three frames 604 constituting the image sequence data 603 is described here as an example, the configuration is not limited thereto. The time of the data of the frame 604c is 0.2 second. Assuming the timescale designated in the media header box 209 is 10, 0.2 seconds is equivalent to 2. Accordingly, if 0 is set for the segment_duration, 2 is set for the media time, and 0 is set for the media rate integer, it is possible to continuously display only the frame 604c, which has a frame number of 3. These settings mean that frames before the frame 604c, which has a frame number of 3, are not displayed, i.e., that the frame 604a, which has a frame number of 1, and the frame 604b, which has a frame number of 2, are not displayed.

Thus according to the present embodiment, in addition to the frame to be saved, the other frames necessary for decoding the frame to be saved are stored in the same still image file. As such, a quality still image file that can be decoded and displayed/played back can be obtained without referring to other files, data, or the like.

### Second Embodiment

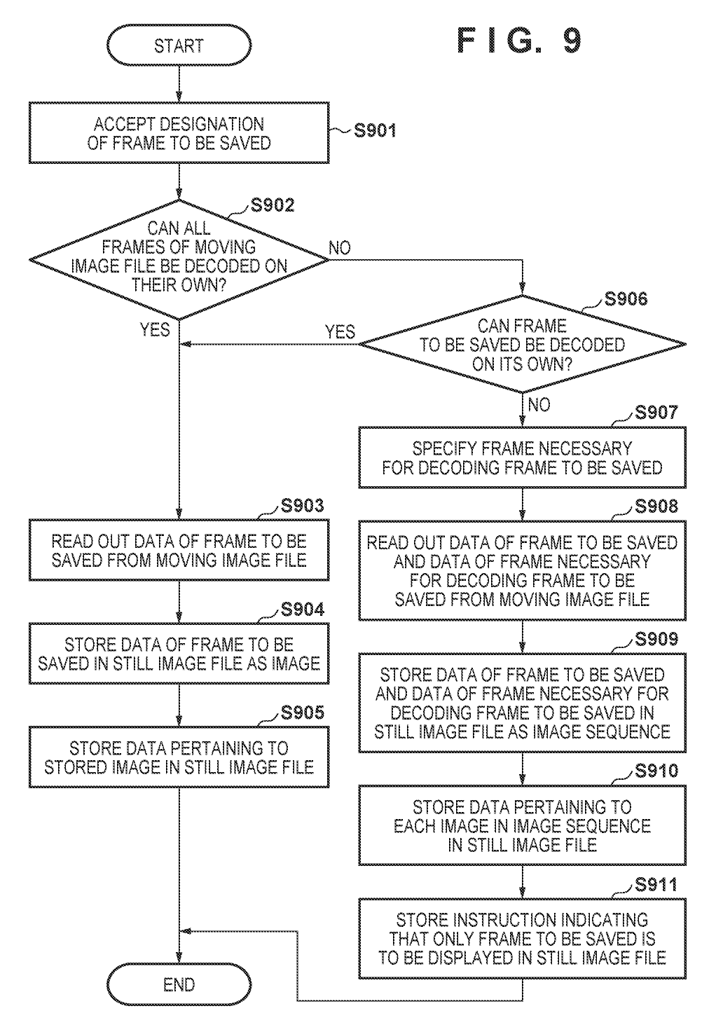

An image processing apparatus and image processing method according to a second embodiment will be described using FIG. 8. Constituent elements that are the same as in the image processing apparatus and image processing method according to the first embodiment, illustrated in FIGS. 1 to 7, will be given the same reference signs, and descriptions thereof will be omitted or simplified.

FIG. 8 is a flowchart illustrating operations performed by the image processing apparatus according to the present embodiment. FIG. 8 illustrates a sequence carried out when recording a moving image.

In step S801, the CPU 403 acquires information specifying the frame to be saved. The process carried out in step S801 is the same as the process carried out in step S501 described in the first embodiment. The process then moves to step S802.

In step S802, the CPU 403 determines whether or not the frame to be saved designated in step S801 can be decoded on its own. As described above, a frame that can be decoded on its own is an IDR frame. In ISOBMFF, the IDR frames are managed by the sync sample box 218. Accordingly, whether or not the frame to be saved can be decoded on its own can be determined on the basis of whether or not the frame number of the designated frame to be saved is registered in the sync sample box 218. If the designated frame to be saved can be decoded on its own (YES in step S802), the process moves to step S803. If the designated frame to be saved cannot be decoded on its own (NO in step S802), the process moves to step S806.

In step S803, the CPU 403 reads out the data of the frame to be saved from the moving image file. Then, the CPU 403 holds the data read out from the moving image file in the RAM 404. The process then moves to step S804.

In step S804, the CPU 403 stores the data of the frame to be saved read out in step S803 in the media data box 112 of the HEIF file as the image data 113. The process then moves to step S805.

In step S805, the CPU 403 stores the data pertaining to the image stored in step S804 in sub boxes within the metadata box 102 of the HEIF file. The processing illustrated in FIG. 8 ends when step S805 is complete. In other words, if the frame to be saved can be decoded on its own, the processing illustrated in FIG. 8 ends once step S805 is complete.

In step S806, the CPU 403 specifies the frames necessary for decoding the designated frame to be saved. The process carried out in step S806 is the same as the process carried out in step S502 described in the first embodiment. The process then moves to step S807.

In step S807, the CPU 403 reads out the data of the designated frame to be saved and the data of the frame specified in step S806 from the moving image file. In other words, the CPU 403 reads out the data of the designated frame to be saved and the data of the frames necessary for decoding the designated frame to be saved from the moving image file. Then, the CPU 403 holds the read-out data in the RAM 404. The process carried out in step S807 is the same as the process carried out in step S503 described in the first embodiment. The process then moves to step S808.

In step S808, the CPU 403 stores data such as that described below in the media data box 112 of the HEIF file. The CPU 403 stores the data of the frame to be saved, which was read out in step S807, and the data of the frames necessary for decoding the data of the frame to be saved, which was read out in step S807, in the media data box 112 of the HEIF file. This data is stored in the media data box 112 of the HEIF file as the image sequence data 224. The process carried out in step S808 is the same as the process carried out in step S504 described in the first embodiment. The process then moves to step S809.

In step S809, the CPU 403 stores the data pertaining to the respective images constituting the image sequence data 224 stored in step S808 in sub boxes within the movie box 201 of the HEIF file. The process carried out in step S809 is the same as the process carried out in step S505 described in the first embodiment. The process then moves to step S810.

In step S810, the CPU 403 carries out the following processing. The CPU 403 stores, in the HEIF file, an instruction for displaying only the frame 604c, which is the frame to be saved, from among the frames 604a to 604c stored in the media data box 112 of the HEIF file in step S809. This instruction for displaying only the frame 604c, which is the frame to be saved, is stored in the edit list box 207. The process carried out in step S810 is the same as the process carried out in step S506 described in the first embodiment.

In this manner, when the frame to be saved can be decoded on its own, that frame to be saved may be stored as an image in the still image file.

### Third Embodiment

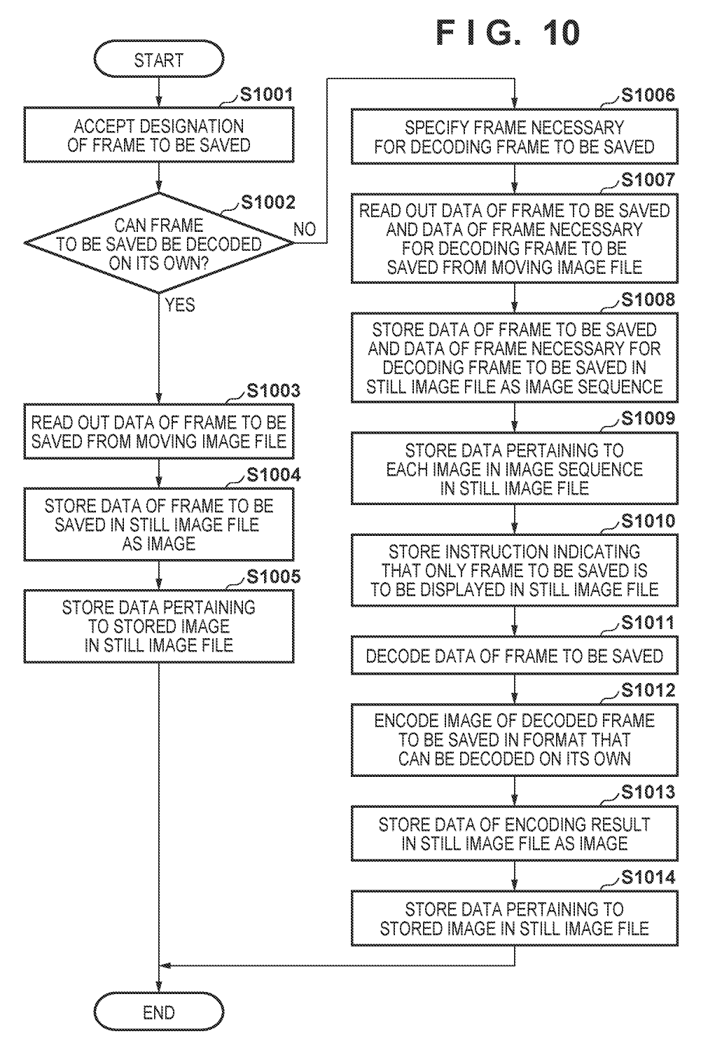

An image processing apparatus and image processing method according to a third embodiment will be described using FIG. 9. Constituent elements that are the same as in the image processing apparatus and image processing method according to the first and second embodiments, illustrated in FIGS. 1 to 8, will be given the same reference signs, and descriptions thereof will be omitted or simplified.

FIG. 9 is a flowchart illustrating operations performed by the image processing apparatus according to the present embodiment. FIG. 9 illustrates a sequence carried out when recording a moving image.

In step S901, the CPU 403 acquires information specifying the frame to be saved. The process carried out in step S901 is the same as the process carried out in step S501 described in the first embodiment. The process then moves to step S902.

In step S902, the CPU 403 determines whether or not all of the frames included in the moving image file can be decoded on their own. As described above, all frames are IDR frames if the sync sample box 218 is not present. Accordingly, whether or not all the frames included in the moving image file can be decoded on their own can be determined on the basis of whether or not the sync sample box 218 is present. If all of the frames included in the moving image file can be decoded on their own (YES in step S902), the process moves to step S903. If a frame that cannot be decoded on its own is included in the moving image file (NO in step S902), the process moves to step S906.

In step S903, the CPU 403 reads out the data of the frame to be saved from the moving image file. Then, the CPU 403 holds the data read out from the moving image file in the RAM 404. The process carried out in step S903 is the same as the process carried out in step S803 described in the second embodiment. The process then moves to step S904.

In step S904, the CPU 403 stores the data of the frame to be saved read out in step S903 in the media data box 112 of the HEIF file as the image data 113. The process carried out in step S904 is the same as the process carried out in step S804 described in the second embodiment. The process then moves to step S905.

In step S905, the CPU 403 stores the data pertaining to the image stored in step S904 in sub boxes within the metadata box 102 of the HEIF file. The process carried out in step S905 is the same as the process carried out in step S805 described in the second embodiment. The processing illustrated in FIG. 9 ends when step S905 is complete. In other words, if the frame to be saved can be decoded on its own, the processing illustrated in FIG. 9 ends once step S905 is complete.

In step S906, the CPU 403 determines whether or not the frame to be saved designated in step S901 can be decoded on its own. As described above, a frame that can be decoded on its own is an IDR frame. In ISOBMFF, the IDR frames are managed by the sync sample box 218. Accordingly, whether or not the frame to be saved can be decoded on its own can be determined on the basis of whether or not the frame number of the designated frame to be saved is registered in the sync sample box 218. If the designated frame to be saved can be decoded on its own (YES in step S906), the process moves to step S903. If the designated frame to be saved cannot be decoded on its own (NO in step S906), the process moves to step S907. The process carried out in step S906 is the same as the process carried out in step S802 described in the second embodiment.

In step S907, the CPU 403 specifies the frames necessary for decoding the designated frame to be saved. The process carried out in step S907 is the same as the process carried out in step S502 described in the first embodiment. The process then moves to step S908.

In step S908, the CPU 403 reads out the data of the designated frame to be saved and the data of the frame specified in step S907 from the moving image file. In other words, the CPU 403 reads out the data of the designated frame to be saved and the data of the frames necessary for decoding the designated frame to be saved from the moving image file. Then, the CPU 403 holds the read-out data in the RAM 404. The process carried out in step S908 is the same as the process carried out in step S503 described in the first embodiment. The process then moves to step S909.

In step S909, the CPU 403 stores data such as that described below in the media data box 112 of the HEIF file. The CPU 403 stores the data of the frame to be saved, which was read out in step S908, and the data of the frames necessary for decoding the data of the frame to be saved, which was read out in step S908, in the media data box 112 of the HEIF file. This data is stored in the media data box 112 of the HEIF file as the image sequence data 224. The process carried out in step S909 is the same as the process carried out in step S504 described in the first embodiment. The process then moves to step S910.

In step S910, the CPU 403 stores the data pertaining to the respective images constituting the image sequence data 224 stored in step S908 in sub boxes within the movie box 201 of the HEIF file. The process carried out in step S910 is the same as the process carried out in step S505 described in the first embodiment. The process then moves to step S911.

In step S911, the CPU 403 carries out the following processing. The CPU 403 stores, in the HEIF file, an instruction for displaying only the frame 604c, which is the frame to be saved, from among the frames 604a to 604c stored in the media data box 112 of the HEIF file in step S909. This instruction for displaying only the frame 604c, which is the frame to be saved, is stored in the edit list box 207. The process carried out in step S911 is the same as the process carried out in step S506 described in the first embodiment.

In this manner, whether or not all of a plurality of frames included in a moving image file can be decoded on their own may be determined.

### Fourth Embodiment

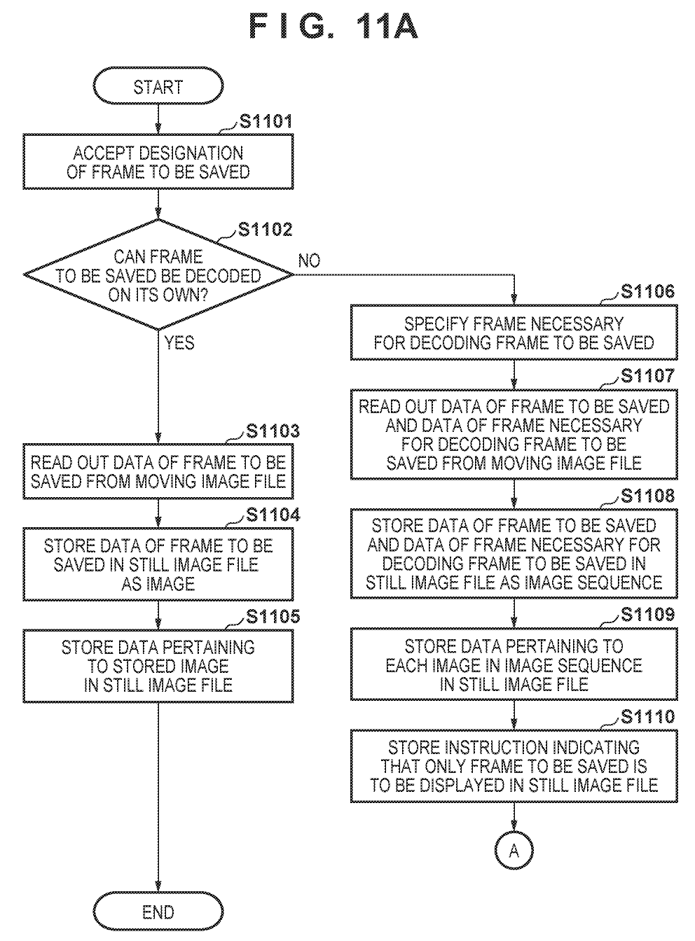

An image processing apparatus and image processing method according to a fourth embodiment will be described using FIG. 10. Constituent elements that are the same as in the image processing apparatus and image processing method according to the first to third embodiments, illustrated in FIGS. 1 to 9, will be given the same reference signs, and descriptions thereof will be omitted or simplified.

The image processing apparatus according to the present embodiment stores both the image data 113 and the image sequence data 224 in an HEIF file.

FIG. 10 is a flowchart illustrating operations performed by the image processing apparatus according to the present embodiment. FIG. 10 illustrates a sequence carried out when recording a moving image. In the present embodiment, both the image data 113 and the image sequence data 224 are stored in an HEIF file such as that illustrated in FIG. 3.

In step S1001, the CPU 403 acquires information specifying the frame to be saved. The process carried out in step S1001 is the same as the process carried out in step S501 described in the first embodiment. The process then moves to step S1002.

In step S1002, the CPU 403 determines whether or not the frame to be saved designated in step S1001 can be decoded on its own. The process carried out in step S1002 is the same as the process carried out in step S802 described in the second embodiment. If the designated frame to be saved can be decoded on its own (YES in step S1002), the process moves to step S1003. If the designated frame to be saved cannot be decoded on its own (NO in step S1002), the process moves to step S1006.

In step S1003, the CPU 403 reads out the data of the frame to be saved from the moving image file. Then, the CPU 403 holds the data read out from the moving image file in the RAM 404. The process carried out in step S1003 is the same as the process carried out in step S803 described in the second embodiment. The process then moves to step S1004.

In step S1004, the CPU 403 stores the data of the frame to be saved read out in step S1003 in the media data box 112 of the HEIF file as the image data 113. The process carried out in step S1004 is the same as the process carried out in step S804 described in the second embodiment. The process then moves to step S1005.

In step S1005, the CPU 403 stores the data pertaining to the image stored in step S1004 in sub boxes within the metadata box 102 of the HEIF file. The process carried out in step S1005 is the same as the process carried out in step S805 described in the second embodiment. The processing illustrated in FIG. 10 ends when step S1005 is complete. In other words, if the frame to be saved can be decoded on its own, the processing illustrated in FIG. 10 ends once step S1005 is complete.

In step S1006, the CPU 403 specifies the frames necessary for decoding the designated frame to be saved. The process carried out in step S1006 is the same as the process carried out in step S502 described in the first embodiment. The process then moves to step S1007.

In step S1007, the CPU 403 reads out the data of the designated frame to be saved and the data of the frame specified in step S1006 from the moving image file. In other words, the CPU 403 reads out the data of the designated frame to be saved and the data of the frames necessary for decoding the designated frame to be saved from the moving image file. Then, the CPU 403 holds the read-out data in the RAM 404. The process carried out in step S1007 is the same as the process carried out in step S503 described in the first embodiment. The process then moves to step S1008.

In step S1008, the CPU 403 stores data such as that described below in the media data box 112 of the HEIF file. The CPU 403 stores the data of the frame to be saved, which was read out in step S1007, and the data of the frames necessary for decoding the data of the frame to be saved, which was read out in step S1007, in the media data box 112 of the HEIF file. This data is stored in the media data box 112 of the HEIF file as the image sequence data 224. The process carried out in step S1008 is the same as the process carried out in step S504 described in the first embodiment. The process then moves to step S1009.

In step S1009, the CPU 403 stores the data pertaining to the respective images constituting the image sequence data 224 stored in step S1008 in sub boxes within the movie box 201 of the HEIF file. The process carried out in step S1009 is the same as the process carried out in step S505 described in the first embodiment. The process then moves to step S1010.

In step S1010, the CPU 403 carries out the following processing. The CPU 403 stores, in the HEIF file, an instruction for displaying only the frame 604c, which is the frame to be saved, from among the frames 604a to 604c stored in the media data box 112 of the HEIF file in step S1008. This instruction for displaying only the frame 604c, which is the frame to be saved, is stored in the edit list box 207. The process carried out in step S1010 is the same as the process carried out in step S506 described in the first embodiment. The process then moves to step S1011.

In step S1011, the CPU 403 decodes the data read out in step S1007. In other words, the data of the designated frame to be saved and the data of the frames necessary for decoding the designated frame to be saved are decoded. As a result, the image of the designated frame to be saved is obtained. The process then moves to step S1012.

In step S1012, the CPU 403 compresses (encodes) the image obtained in step S1011, i.e., the image of the designated frame to be saved, in a format in which the image can be decoded on its own. The coding format used in step S1012 may be different from the coding format of the original moving image. For example, the image of the frame to be saved may be compressed using the JPEG format even if the coding format of the original moving image was HEVC. The process then moves to step S1013.

In step S1013, the CPU 403 stores the data obtained from the coding carried out in step S1012 in the HEIF file as the image data 113. The process then moves to step S1014.

In step S1014, the CPU 403 stores the data pertaining to the image stored in step S1013 in sub boxes within the metadata box 102 of the HEIF file. The process carried out in step S1014 is the same as the process carried out in step S805 described in the second embodiment.

In this manner, the frame to be saved may be decoded, the decoded frame to be saved may be encoded in a format in which the frame can be decoded on its own, and the encoded frame may then be stored in the still image file. According to the present embodiment, a frame encoded in a format in which the frame can be decoded on its own is also stored in the still image file, which makes it possible to obtain a still image file having broad compatibility.

### Fifth Embodiment

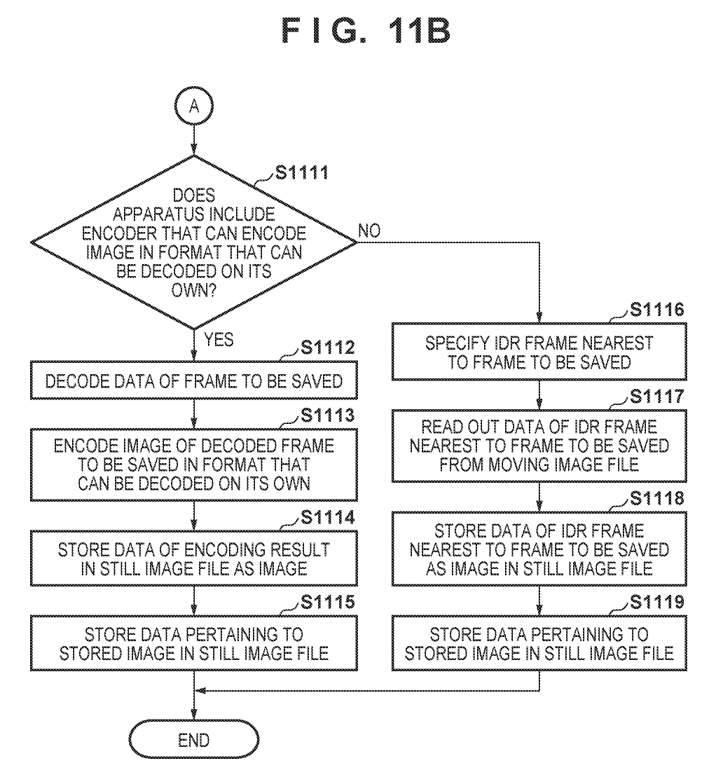

An image processing apparatus and image processing method according to a fifth embodiment will be described using FIGS. 11A and 11B. Constituent elements that are the same as in the image processing apparatus and image processing method according to the first to fourth embodiments, illustrated in FIGS. 1 to 10, will be given the same reference signs, and descriptions thereof will be omitted or simplified.

FIGS. 11 A and 11B are flowcharts illustrating operations performed by the image processing apparatus according to the present embodiment. FIGS. 11 A and 11B illustrate a sequence carried out when recording a moving image.

In step S1101, the CPU 403 acquires information specifying the frame to be saved. The process carried out in step S1101 is the same as the process carried out in step S501 described in the first embodiment. The process then moves to step S1102.

In step S1102, the CPU 403 determines whether or not the frame to be saved designated in step S1101 can be decoded on its own. The process carried out in step S1102 is the same as the process carried out in step S802 described in the second embodiment. If the designated frame to be saved can be decoded on its own (YES in step S1102), the process moves to step S1103. If the designated frame to be saved cannot be decoded on its own (NO in step S1102), the process moves to step S1106.

In step S1103, the CPU 403 reads out the data of the frame to be saved from the moving image file. Then, the CPU 403 holds the data read out from the moving image file in the RAM 404. The process carried out in step S1103 is the same as the process carried out in step S803 described in the second embodiment. The process then moves to step S1104.

In step S1104, the CPU 403 stores the data of the frame to be saved read out in step S1103 in the media data box 112 of the HEIF file as the image data 113. The process carried out in step S1104 is the same as the process carried out in step S804 described in the second embodiment. The process then moves to step S1105.

In step S1105, the CPU 403 stores the data pertaining to the image stored in step S1004 in sub boxes within the metadata box 102 of the HEIF file. The process carried out in step S1105 is the same as the process carried out in step S805 described in the second embodiment. The processing illustrated in FIG. 11A ends when step S1105 is complete. In other words, if the frame to be saved can be decoded on its own, the processing illustrated in FIG. 11A ends once step S1105 is complete.

In step S1106, the CPU 403 specifies the frames necessary for decoding the designated frame to be saved. The process carried out in step S1106 is the same as the process carried out in step S502 described in the first embodiment. The process then moves to step S1107.

In step S1107, the CPU 403 reads out the data of the designated frame to be saved and the data of the frame specified in step S1106 from the moving image file. In other words, the CPU 403 reads out the data of the designated frame to be saved and the data of the frames necessary for decoding the designated frame to be saved from the moving image file. Then, the CPU 403 holds the read-out data in the RAM 404. The process carried out in step S1107 is the same as the process carried out in step S503 described in the first embodiment. The process then moves to step S1008.

In step S1108, the CPU 403 stores data such as that described below in the media data box 112 of the HEIF file. The CPU 403 stores the data of the frame to be saved, which was read out in step S1107, and the data of the frames necessary for decoding the data of the frame to be saved, which was read out in step S1007, in the media data box 112 of the HEIF file. This data is stored in the media data box 112 of the HEIF file as the image sequence data 224. The process carried out in step S1108 is the same as the process carried out in step S504 described in the first embodiment. The process then moves to step S1109.

In step S1109, the CPU 403 stores the data pertaining to the respective images constituting the image sequence data 224 stored in step S1108 in sub boxes within the movie box 201 of the HEIF file. The process carried out in step S1109 is the same as the process carried out in step S505 described in the first embodiment. The process then moves to step S1110.

In step S1110, the CPU 403 carries out the following processing. The CPU 403 stores, in the HEIF file, an instruction for displaying only the frame 604c, which is the frame to be saved, from among the frames 604a to 604c stored in the media data box 112 of the HEIF file in step S1109. This instruction for displaying only the frame 604c, which is the frame to be saved, is stored in the edit list box 207. The process carried out in step S1110 is the same as the process carried out in step S506 described in the first embodiment. The process then moves to step S1111.

In step S1111, the CPU 403 determines whether or not the image processing apparatus according to the present embodiment includes an encoder that can encode the data of the frame to be saved in a format in which the data can be decoded on its own. If the image processing apparatus according to the present embodiment includes such an encoder (YES in step S1111), the process moves to step S1112. If the image processing apparatus according to the present embodiment does not include such an encoder (NO in step S1111), the process moves to step S1116.

In step S1112, the CPU 403 decodes the data read out in step S1107. In other words, the data of the designated frame to be saved and the data of the frames necessary for decoding the designated frame to be saved are decoded. As a result, the image of the designated frame to be saved is obtained. The process carried out in step S1112 is the same as the process carried out in step S1011 described in the fourth embodiment. The process then moves to step S1113.

In step S1113, the CPU 403 compresses (encodes) the image obtained in step S1112, i.e., the image of the designated frame to be saved, in a format in which the image can be decoded on its own. The coding format used in step S1113 may be different from the coding format of the original moving image. For example, the image of the frame to be saved may be compressed using the JPEG format even if the coding format of the original moving image was HEVC. The process carried out in step S1113 is the same as the process carried out in step S1012 described in the fourth embodiment. The process then moves to step S1114.

In step S1114, the CPU 403 stores the data obtained from the coding carried out in step S1113 in the HEIF file as the image data 113. The process carried out in step S1114 is the same as the process carried out in step S1013 described in the fourth embodiment. The process then moves to step S1115.

In step S1115, the CPU 403 stores the data pertaining to the image stored in step S1114 in sub boxes within the metadata box 102 of the HEIF file. The process carried out in step S1115 is the same as the process carried out in step S805 described in the second embodiment.

In step S1116, the CPU 403 specifies the IDR frame nearest to the designated frame to be saved. As described above, in ISOBMFF, the frame numbers of the IDR frames are managed by the sync sample box 218 within the sample table box 212. As such, of the frame numbers of the IDR frames managed by the sync sample box 218, the frame number nearest to the frame number of the frame to be saved corresponds to the frame number of the IDR frame nearest to the frame to be saved. The process then moves to step S1117.

In step S1117, the CPU 403 reads out the data of the frame specified in step S1116, i.e., the data of the IDR frame nearest to the frame to be saved, from the moving image file. The CPU 403 then holds the data read out from the moving image file in the RAM 404. The process then moves to step S1118.

In step S1118, the CPU 403 stores the data read out from the moving image file in step S1117, i.e., the data of the IDR frame nearest to the frame to be saved, in the HEIF file as an image. The process then moves to step S1119.

In step S1119, the CPU 403 stores the data pertaining to the image stored in step S1117 in sub boxes within the metadata box 102 of the HEIF file. The process carried out in step S1119 is the same as the process carried out in step S805 described in the second embodiment.

In this manner, if the image processing apparatus does not include an encoder that can encode the frame to be saved in a format in which the frame can be decoded on its own, the frame that is nearest to the frame to be saved and that can be decoded on its own may be stored in the still image file.

### Sixth Embodiment

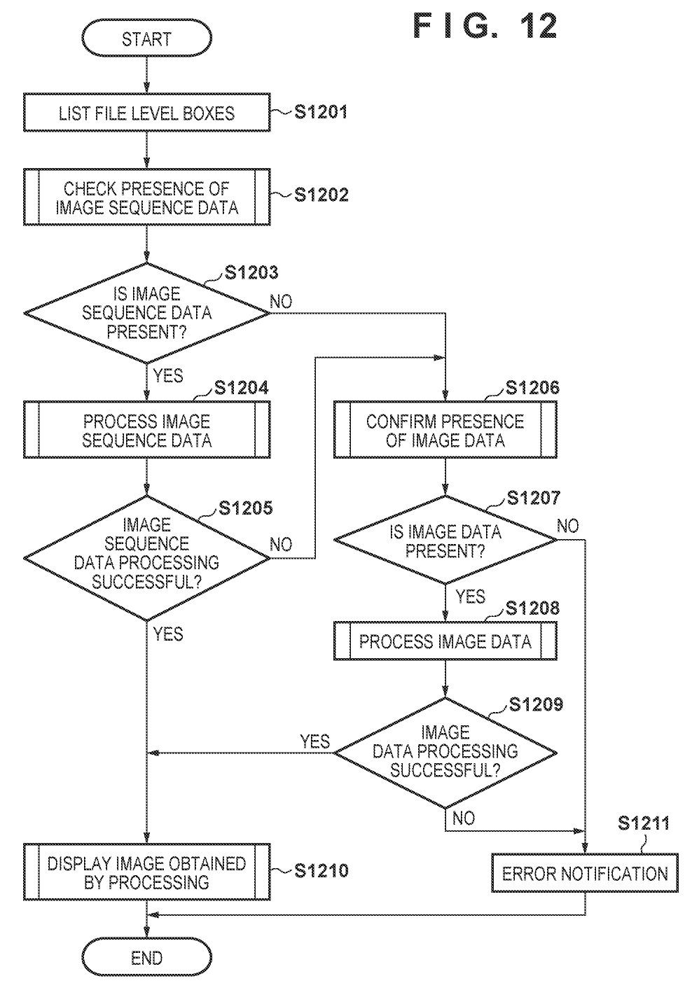

An image processing apparatus and image processing method according to a sixth embodiment will be described using FIG. 12.

Constituent elements that are the same as in the image processing apparatus and image processing method according to the first to fifth embodiments, illustrated in FIGS. 1 to 11, will be given the same reference signs, and descriptions thereof will be omitted or simplified.

FIG. 12 is a flowchart illustrating operations performed by the image processing apparatus according to the present embodiment. FIG. 12 illustrates a sequence carried out when displaying a still image.

In step S1201, the CPU 403 lists the file level boxes included in the HEIF file to be processed. As described above, a file level box is a box that is not a sub box of another box and that can be accessed even when located at the start of the file.

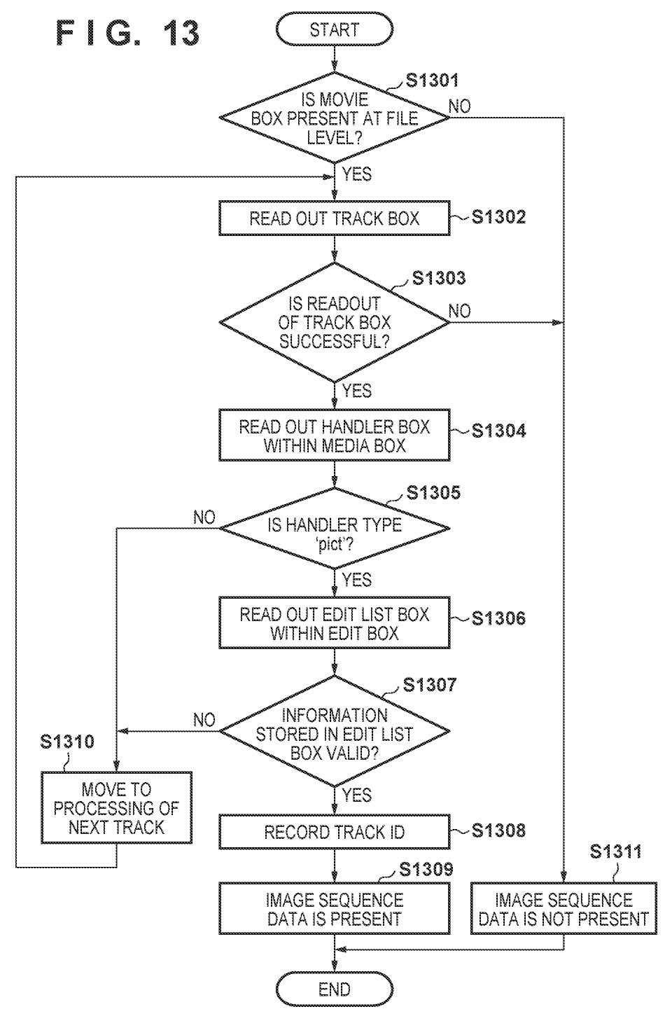

In step S1202, the CPU 403 determines whether or not the image sequence data 224 is present in the HEIF file to be processed. As described above, the “image sequence” is a collection of a plurality of still images having a dependency relationship. Also as described above, a “plurality of still images having a dependency relationship” is a collection of still images having a reference relationship at the time of encoding, such as a collection of still images obtained through inter-frame coding. Thus as described above, to decode still image data belonging to an image sequence, it is necessary to also decode the other still images that were referred to when the still image to be decoded was encoded. The processing carried out in step S1202 will be described in detail later using FIG. 13. If the image sequence data 224 is present in the HEIF file to be processed (YES in step S1203), the process moves to step S1204. If the image sequence data 224 is not present in the HEIF file to be processed (NO in step S1203), the process moves to step S1206.

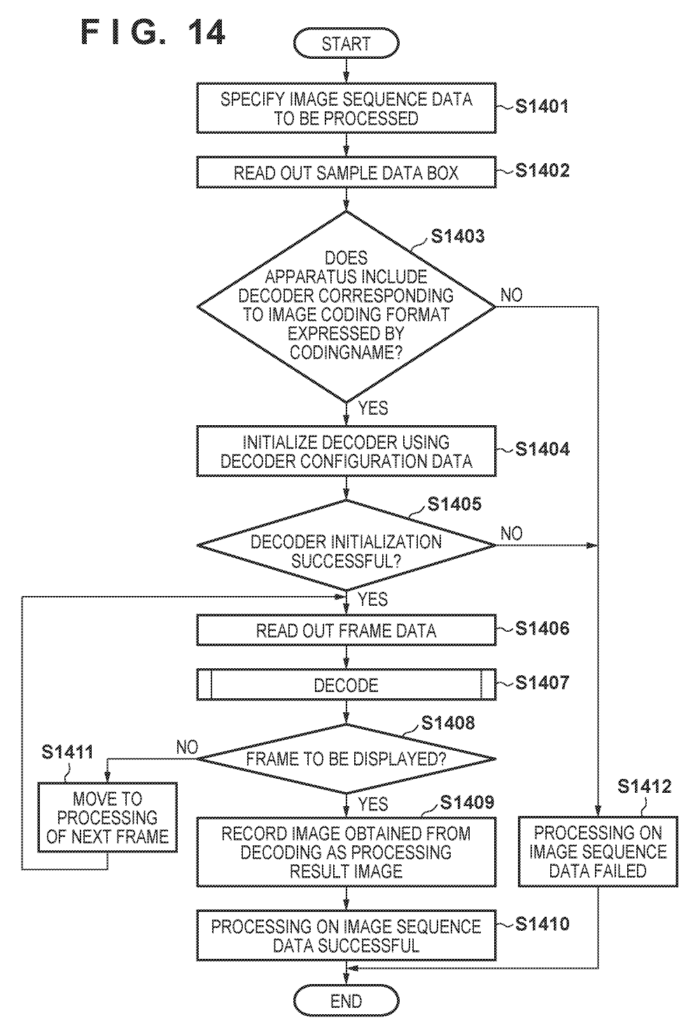

In step S1204, the CPU 403 processes the image sequence data 224. The processing carried out in step S1204 will be described in detail later using FIG. 14. If the image sequence data 224 has been successfully processed (YES in step S1205), the process moves to step S1210. If the image sequence data 224 has not been successfully processed (NO in step S1205), the process moves to step S1206.

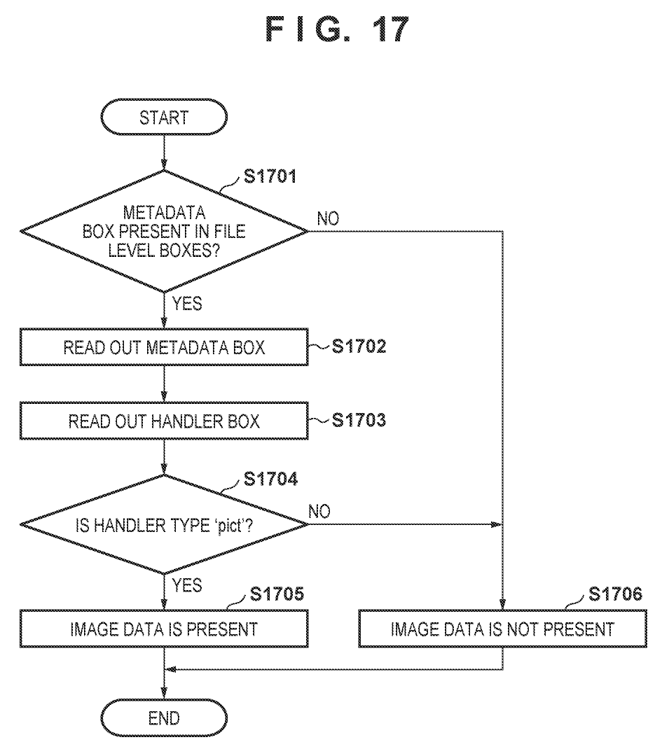

In step S1206, the CPU 403 confirms whether or not the image data 113 is present in the HEIF file to be processed. As described above, the “image data” is still image data lacking a reference relationship at the time of encoding, i.e., a single piece of still image data. The processing carried out in step S1206 will be described in detail later using FIG. 17. If the image data 113 is present in the HEIF file to be processed (YES in step S1207), the process moves to step S1208. If the image data 113 is not present in the HEIF file to be processed (NO in step S1207), the process moves to step S1211.

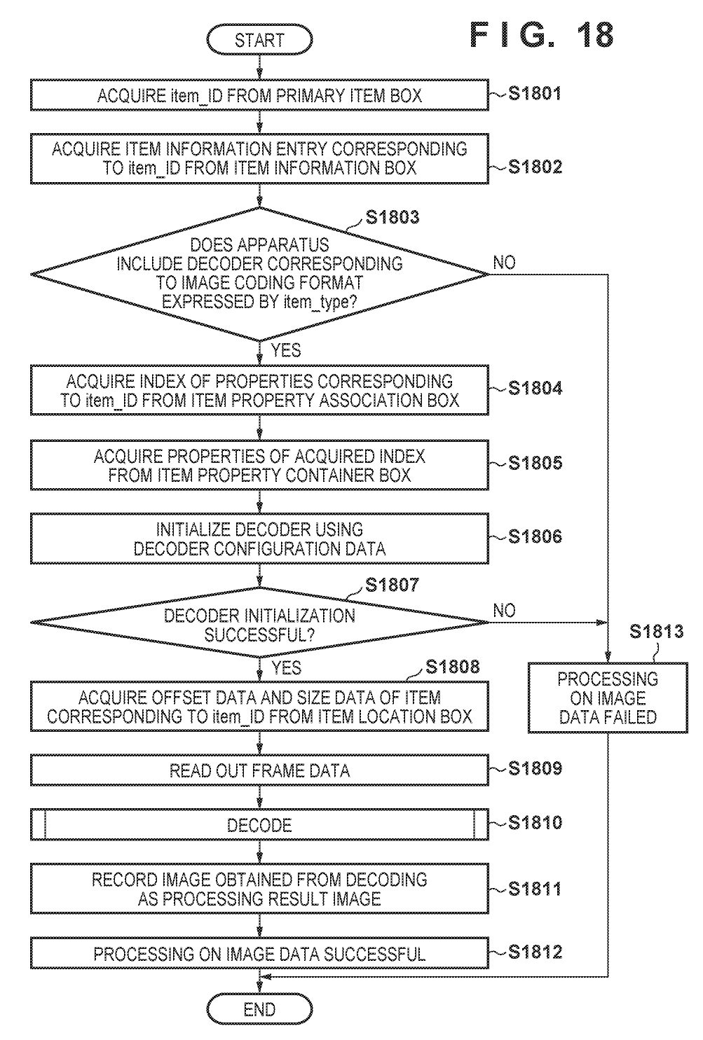

In step S1208, the CPU 403 processes the image data. The processing carried out in step S1208 will be described in detail later using FIG. 18. The process then moves to step S1209. If the image data has been successfully processed (YES in step S1209), the process moves to step S1210. If the image data has not been successfully processed (NO in step S1209), the process moves to step S1211.

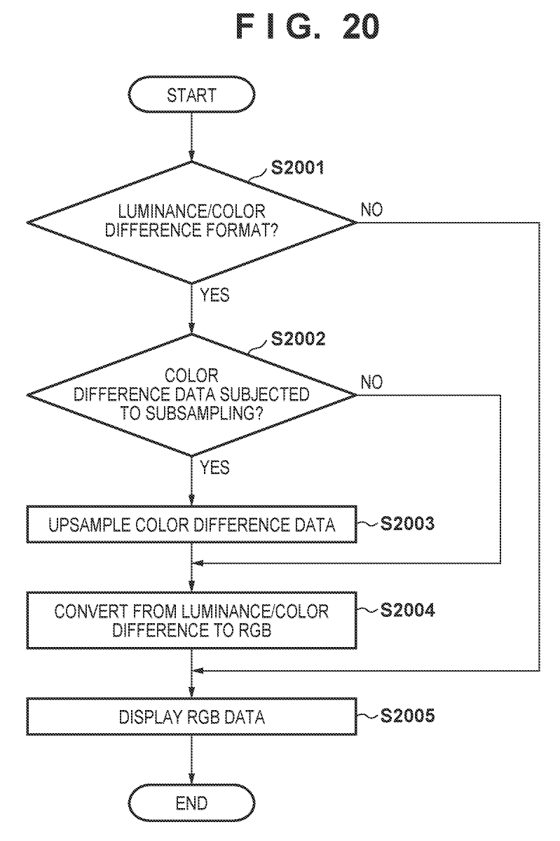

In step S1210, the CPU 403 displays the image obtained through the process of step S1204 or the image obtained through the process of step S1208. The processing carried out in step S1210 will be described in detail later using FIG. 20.

In step S1211, the CPU 403 makes an error notification. In other words, an error is displayed in the display unit 402 if neither the image sequence data 224 nor the image data 113 are present in the HEIF file to be processed.

The processing illustrated in FIG. 12 is carried out in this manner.

The processing carried out in step S1202, i.e., the process of determining whether or not the image sequence data 224 is present in the HEIF file to be processed, will be described using FIG. 13. FIG. 13 is a flowchart illustrating operations performed by the image processing apparatus according to the present embodiment. FIG. 13 illustrates a sequence for determining whether or not the image sequence data 224 is present in the HEIF file to be processed.

In step S1301, the CPU 403 checks whether or not the movie box 201 is present in the file level boxes listed in step S1201. If the movie box 201 is present in the file level boxes listed in step S1201 (YES in step S1301), the process moves to step S1302. If the movie box 201 is not present in the file level boxes listed in step S1201 (NO in step S1301), the process moves to step S1311.

In step S1302, the CPU 403 reads out the track box 204 included in the movie box 201. The process then moves to step S1303.

In step S1303, the CPU 403 determines whether or not the track box 204 has been successfully read out. If the track box 204 has been successfully read out (YES in step S1303), the process moves to step S1304. If the track box 204 has not been successfully read out (NO in step S1303), the process moves to step S1311.

In step S1304, the CPU 403 reads out the handler box 210 included in the media box 208 within the track box 204. The process then moves to step S1305.

In step S1305, the CPU 403 determines whether or not the handler type of the handler box 210 read out in step S1304 is “pict”. If the handler type of the handler box 210 read out in step S1304 is “pict” (YES in step S1305), the process moves to step S1306. If the handler_type of the handler box 210 read out in step S1304 is not “pict” (NO in step S1305), the process moves to step S1310.

In step S1306, the CPU 403 reads out the edit list box 207 included in the edit box 206 within the track box 204. The process then moves to step S1307.

In step S1307, the CPU 403 determines whether or not the information stored in the edit list box 207 is valid. As described above, the edit list box 207 stores information associating a time corresponding to an image (frame) to be displayed with a track time (display time). For example, if 0 is set for the segment_duration, the information corresponding to the frame to be displayed is set for media time, and 0 is set for the media rate integer, the frame to be displayed can be displayed as a still image. The information stored in the edit list box 207 is considered valid if information that enables the image sequence data 224 to be displayed as a still image is stored in the edit list box 207. The information stored in the edit list box 207 is considered invalid if information that enables the image sequence data 224 to be displayed as a still image is not stored in the edit list box 207. If the information stored in the edit list box 207 is valid (YES in step S1307), the process moves to step S1308. If the information stored in the edit list box 207 is invalid (NO in step S1307), the process moves to step S1310.

In step S1308, the CPU 403 records the track ID of that track as the track ID of the track of the image sequence data 224.

In step S1309, the CPU 403 determines that the image sequence data 224 is present in the HEIF file to be processed.

In step S1310, the processing moves to the track box 204 after the track box 204 currently being processed. In other words, the process returns to step S1302. As described above, a plurality of track boxes 204 are sometimes included in the movie box 201.

In step S1311, the CPU 403 determines that the image sequence data 224 is not present in the HEIF file to be processed.

In this manner, it is determined whether or not the image sequence data 224 is present in the HEIF file to be processed.

The processing carried out in step S1204, i.e., the processing carried out on the image sequence data 224, will be described using FIG. 14. FIG. 14 is a flowchart illustrating operations performed by the image processing apparatus according to the present embodiment. FIG. 14 illustrates a sequence for processing the image sequence data 224.

In step S1401, the CPU 403 specifies the track corresponding to the track ID recorded in step 51308 as the track of the image sequence data 224 to be processed.

In step S1402, the CPU 403 reads out the sample table box 212 included in the track box 204 of the track specified in step S1401. As described above, the sample table box 212 is included within the media information box 211. Also as described above, the media information box 211 is included within the media box 208. Furthermore, as described above, the media box 208 is included within the track box 204.

In step S1403, the CPU 403 carries out the following processing. The CPU 403 determines whether or not the image processing apparatus according to the present embodiment includes a decoder (a decoding function) corresponding to the image coding format expressed by the codingname of the sample entry stored in the sample description box 213. As described above, the sample description box 213 is included within the sample table box 212. Also as described above, the sample table box 212 is read out in step S1402. If the image coding format is HEVC, the codingname is “hvcl”. If the image processing apparatus according to the present embodiment includes a decoder corresponding to the image coding format expressed by the codingname (YES in step S1403), the process moves to step S1404. If the image processing apparatus according to the present embodiment does not include a decoder corresponding to the image coding format expressed by the codingname (NO in step S1403), the process moves to step S1412.

In step S1404, the CPU 403 initializes the decoder using HEVC decoder configuration data stored in an HEVC configuration box 1501 included in the visual sample entry 1500. FIG. 15 is a diagram illustrating an example of the visual sample entry. As illustrated in FIG. 15, the visual sample entry 1500 stores a codingname field, a width field, a height field, and other fields. As described above, if the image coding format is HEVC, the codingname is “hvcl”. The visual sample entry 1500 further includes the HEVC configuration box 1501, which has a data type of “hvcC”; a color information box 1502, which has a data type of “colr”; and other boxes 1503. The HEVC configuration box 1501 stores the HEVC decoder configuration data. The color information box 1502 stores a matrix and other fields. In this manner, in step S1404, the decoder is initialized using the HEVC decoder configuration data stored in the HEVC configuration box 1501 included in the visual sample entry 1500. The process then moves to step S1405.

In step S1405, the CPU 403 determines whether or not the decoder has been successfully initialized in step S1404. Various profiles and levels are defined in HEVC, and thus even if the decoder can decode HEVC images, it is not necessarily the case that the decoder can decode all HEVC images. Profiles, levels, and the like are included in the HEVC decoder configuration data stored in the HEVC configuration box 1501. The CPU 403 can determine whether or not an image can be decoded by the decoder included in the image processing apparatus according to the present embodiment on the basis of the HEVC decoder configuration data stored in the HEVC configuration box 1501. If the initialization process of the decoder has succeeded (YES in step S1405), the process moves to step S1406. If the initialization process of the decoder has failed (NO in step S1405), the process moves to step S1412.

In step S1406, the CPU 403 reads out the frame data from the HEIF file to be processed. The data stored in the decode time-sample box 214, the sample size box 215, the sample-chunk box 216, and the chunk offset box 217 is used as this time. As described above, the decode time-sample box 214, the sample size box 215, the sample-chunk box 216, and the chunk offset box 217 are stored in the sample table box 212.

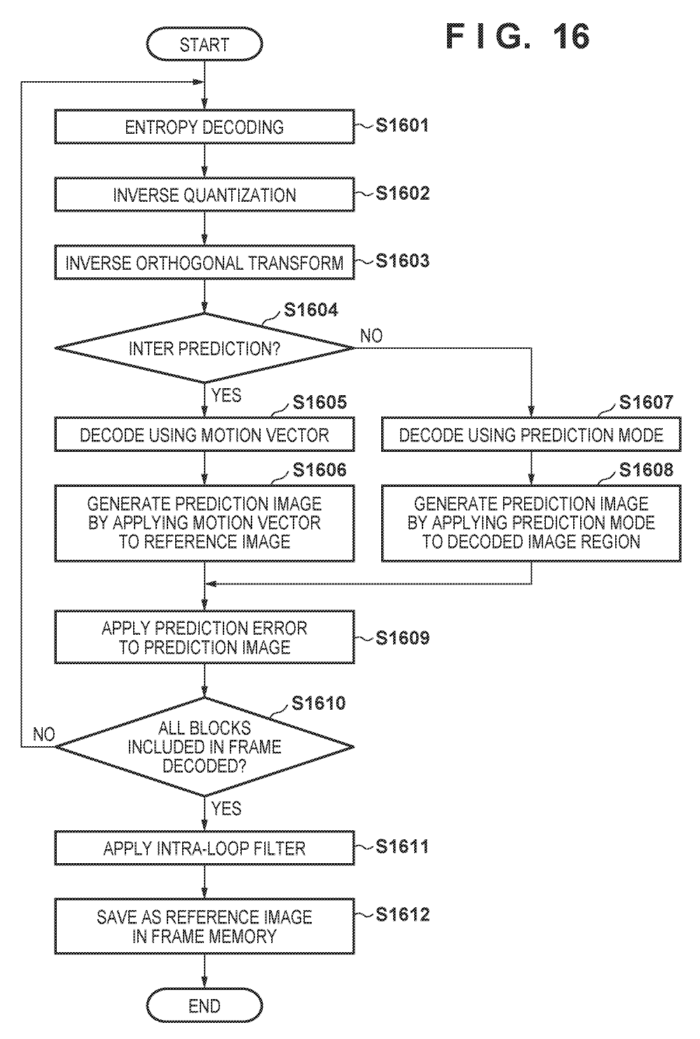

In step S1407, the CPU 403 decodes the frame data read out in step S1406. The process of decoding the frame data will be described later using FIG. 16. The process then moves to step S1408.

In step S1408, the CPU 403 determines whether or not the frame data (image data) obtained from the decoding carried out in step S1407 is frame data to be displayed. As described above, of the image sequence data 224, the frame data to be displayed is the frame data from a time designated by the media time stored in the edit list box 207. The CPU 403 finds the display time of the frame data decoded in step S1407 on the basis of the data stored in the decode time sample box 214. The CPU 403 then determines whether or not that display time is the same as the time designated by the media time stored in the edit list box 207. If these times are the same, the frame data obtained as a result of the decoding carried out in step S1407 is the frame data to be displayed. However, if these times are different, the frame data obtained as a result of the decoding carried out in step S1407 is not the frame data to be displayed. If the frame data obtained as a result of the decoding carried out in step S1407 is the frame data to be displayed (YES in step S1408), the process moves to step S1409. If the frame data obtained as a result of the decoding carried out in step S1407 is not the frame data to be displayed (NO in step S1408), the process moves to step S1411.

In step S1409, the CPU 403 records the image data (the image) obtained as a result of the decoding carried out in step S1407 as processing result image data (a processing result image). The process then moves to step S1410.

In step S1410, the CPU 403 records an indication that the image sequence data 224 has been successfully processed.

In step S1411, the processing moves to the frame following the frame currently being processed.

In step S1412, the CPU 403 records an indication that the image sequence data 224 has not been successfully processed.

The processing illustrated in FIG. 14 is carried out in this manner.

The processing carried out in step S1407, i.e., the process of decoding the frame data, will be described using FIG. 16. FIG. 16 is a flowchart illustrating operations performed by the image processing apparatus according to the present embodiment. FIG. 16 illustrates a sequence for the process of decoding the frame data. A frame is compressed and encoded after being divided into small regions called “blocks”. As such, the processing from step S1601 to step S1609, described hereinafter, is carried out in order on each of the blocks.

In step S1601, the CPU 403 obtains a quantization coefficient by carrying out entropy decoding.

In step S1602, the CPU 403 acquires a conversion coefficient by inverse-quantizing the quantization coefficient acquired in step S1601.

In step S1603, the CPU 403 acquires a prediction error by carrying out an inverse orthogonal transform on the conversion coefficient acquired in step S1602.

In step S1604, it is determined whether or not a prediction mode for the block to be processed is inter prediction. “Inter prediction” is prediction in which a prediction reference image used at the time of encoding is an image aside from the image being processed, i.e., inter-frame predication. Inter prediction is used in inter-frame coding. Prediction that is not inter prediction is intra prediction. “Intra prediction” is prediction in which the prediction reference image used at the time of encoding is an encoded region of the image to be processed, i.e., intra-frame prediction. In a frame subjected to intra-frame coding, the prediction mode is intra prediction for all of the blocks included in the frame. The prediction mode for the blocks included in a frame that has been subjected to inter-frame coding may be inter prediction, or may be intra prediction. If the prediction mode of the block to be processed is inter prediction (YES in step S1604), the process moves to step S1605. If the prediction mode of the block to be processed is not inter prediction (NO in step S1604), i.e., if the prediction mode of the block to be processed is intra prediction, the process moves to step S1607.

In step S1605, the CPU 403 determines to carry out decoding using a motion vector. The process then moves to step S1606.

In step S1606, the CPU 403 generates a prediction image by applying the motion vector to a reference image recorded in frame memory (a frame buffer) in the decoding process carried out on a frame before the frame in question. The process then moves to step S1609.

In step S1607, the CPU 403 determines to carry out decoding in accordance with the prediction mode of the block. The process then moves to step S1608.

In step S1608, the CPU 403 generates a prediction image by applying the prediction mode to a decoded image region among the frames included in that block. The process then moves to step S1609.

In step S1609, the CPU 403 carries out the following processing. The CPU 403 generates a block-decoded image, in which some of the blocks in the frame have been decoded, by applying the prediction error acquired in step S1603 to the prediction image acquired in step S1606 or step S1608. The process then moves to step S1610.

In step S1610, the CPU 403 determines whether or not the decoding is complete for all of the blocks in the frame. If the decoding is complete for all the blocks within the frame (YES in step S1610), the process moves to step S1611. If the decoding is not complete for all of the blocks in the frame (NO in step S1610), the process returns to step S1601.

In step S1611, the CPU 403 applies an intra-loop filter to the image obtained as a result of the decoding. The intra-loop filter is a filter for reducing coding distortion (block distortion, ringing distortion, and the like) produced by quantization processes carried out within the coding loop. The intra-loop filter includes a deblocking filter that reduces block distortion.

In step S1612, the CPU 403 records the image that has been subjected to the intra-loop filtering process in the frame memory as a reference image. The reference image recorded in the frame memory can be used in inter prediction carried out when decoding other frames.

Although a case where the CPU 403 executes the decoding process on the frame data has been described here as an example, the decoding process may be executed on the frame data by a GPU (not shown) included in the display unit 402.

The processing illustrated in FIG. 16 is carried out in this manner.

The processing carried out in step S1206, i.e., the process of confirming whether or not the image data 113 is present in the HEIF file to be processed, will be described using FIG. 17. FIG. 17 is a flowchart illustrating operations performed by the image processing apparatus according to the present embodiment. FIG. 17 illustrates the sequence of a process for confirming whether or not the image data 113 is present in the HEIF file to be processed.

In step S1701, the CPU 403 confirms whether or not the metadata box 102 is present in the file level boxes listed in step S1201. If the metadata box 102 is present in the file level boxes listed in step S1201 (YES in step S1701), the process moves to step S1702. If the metadata box 102 is not present in the file level boxes listed in step S1201 (NO in step S1701), the process moves to step S1706.

In step S1702, the CPU 403 reads out the metadata box 102. The process then moves to step S1703.

In step S1703, the CPU 403 reads out the handler box 103 included in the metadata box 102. The process then moves to step S1704.

In step S1704, the CPU 403 determines whether or not the handler type of the handler box 103 read out in step S1703 is “pict”. If the handler type is “pict” (YES in step S1704), the process moves to step S1705. If the handler type is not “pict” (NO in step S1704), the process moves to step S1706.

In step S1705, the CPU 403 stores an indication that the image data 113 is present in that HEIF file.

In step S1706, the CPU 403 stores an indication that the image data is not present in that HEIF file.

The processing illustrated in FIG. 17 is carried out in this manner.

The processing carried out in step S1208, i.e., the image data processing, will be described using FIG. 18. FIG. 18 is a flowchart illustrating operations performed by the image processing apparatus according to the present embodiment. FIG. 18 illustrates a sequence for the image data processing.

In step S1801, the CPU 403 acquires the item ID (item_ID) from the primary item box 104 included in the metadata box 102 read out in step S1702. The process then moves to step S1802.

In step S1802, the CPU 403 carries out the following processing. The CPU 403 acquires the item information entry 106 corresponding to the item ID acquired in step S1801, from the item information box 105 included in the metadata box 102 read out in step S1702. The process then moves to step S1803.

In step S1803, the CPU 403 makes the following determination. The CPU 403 determines whether or not the image processing apparatus according to the present embodiment includes a decoder (a decoding function) corresponding to the image coding format expressed by the item type stored in the item information entry 106 acquired in step S1802. If the image coding format is HEVC, the item type (item type) is “hvcl”. If the image processing apparatus according to the present embodiment includes a decoder corresponding to the image coding format expressed by the item type (YES in step S1803), the process moves to step S1804. If the image processing apparatus according to the present embodiment does not include a decoder corresponding to the image coding format expressed by the item type (NO in step S1803), the process moves to step S1813.

In step S1804, the CPU 403 carries out the following processing. The CPU 403 acquires an index of properties corresponding to the item ID acquired in step S1801, from the item properties association box 110 included in the metadata box 102 read out in step S1702. Note that the item properties association box 110 is included in the item properties box 108, which itself is included in the metadata box 102. The process then moves to step S1805.

In step S1805, the CPU 403 acquires properties corresponding to the index acquired in step S1804, from the item properties container box 109 in the metadata box 102 read out in step S1702. Note that the item properties container box 109 is included in the item properties box 108, which itself is included in the metadata box 102. The process then moves to step S1806.

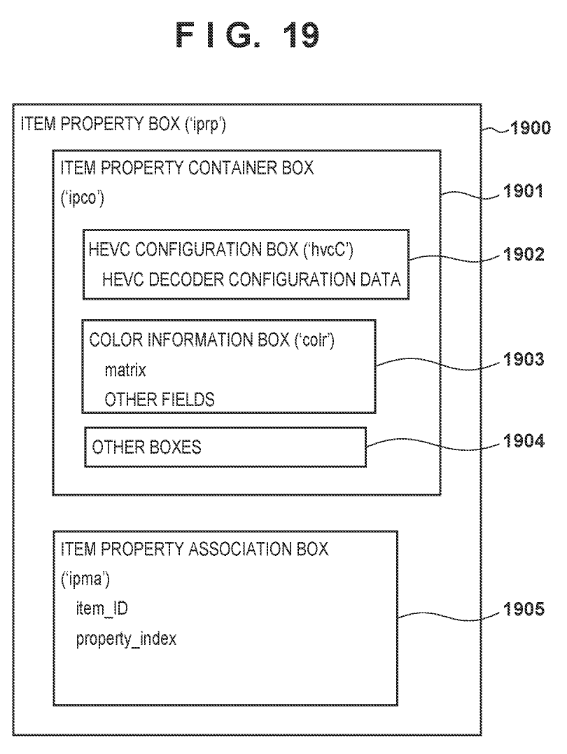

In step S1806, the CPU 403 initializes the decoder using HEVC decoder configuration data stored in an HEVC configuration box 1902 included in the item properties box 108. FIG. 19 is a diagram illustrating an example of the item property box. As illustrated in FIG. 19, and item property box 1900 includes an item property container box 1901, which has a data type of “ipco”, and an item property association box 1905, which has a data type of “ipma”. The item property container box 1901 further includes the HEVC configuration box 1902, which has a data type of “hvcC”; a color information box 1903, which has a data type of “colr”; and other boxes 1904. The HEVC configuration box 1902 stores the HEVC decoder configuration data. The color information box 1903 stores a matrix and other fields. The item property association box 1905 stores an item_ID and a property_index. In this manner, in step S1806, the decoder is initialized using the HEVC decoder configuration data stored in the HEVC configuration box 1902 included in the item property container box 1901. The process then moves to step S1807.

In step S1807, the CPU 403 determines whether or not the decoder has been successfully initialized in step S1806. The processing carried out in step S1807 is the same as the processing carried out in step S1405. If the initialization process of the decoder has succeeded (YES in step S1807), the process moves to step S1808. If the initialization process of the decoder has failed (NO in step S1807), the process moves to step S1813.

In step S1808, the CPU 403 carries out the following processing. The CPU 403 acquires offset data and size data of the item corresponding to the item ID acquired in step S1801, from the item location box 107 within the metadata box 102 read out in step S1702. The offset data indicates the location of the item, and the size data indicates the size of the item. The process then moves to step S1809.

In step S1809, the CPU 403 reads out the frame data from the HEIF file to be processed, on the basis of the offset data and the size data acquired in step S1808. The process then moves to step S1810.

In step S1810, the CPU 403 decodes the frame data read out in step S1809. The processing carried out in step S1810 is the same as the processing carried out in step S1407. The process then moves to step S1811.

In step S1811, the CPU 403 records the image data (the image) obtained as a result of the decoding carried out in step S1810 as processing result image data (a processing result image). The process then moves to step S1812.

In step S1812, the CPU 403 records an indication that the image data has been successfully processed.

In step S1813, the CPU 403 records an indication that the image data has not been successfully processed.

The processing illustrated in FIG. 18 is carried out in this manner.

The processing carried out in step S1210, i.e., the processing for displaying the image obtained through the processing, will be described using FIG. 20. FIG. 20 is a flowchart illustrating operations performed by the image processing apparatus according to the present embodiment. FIG. 20 illustrates a sequence of the processing for displaying the image obtained through the processing.

In step S2001, the CPU 403 checks whether or not a pixel format of the processing result image data recorded in step S1409 or step S1811 is a luminance/color difference format. If the pixel format of the processing result image data is a luminance/color difference format (YES in step S2001), the process moves to step S2002. If the pixel format of the processing result image data is not a luminance/color difference format (NO in step S2001), i.e., if the pixel format of the processing result image data is the RGB format, the process moves to step S2005.

In step S2002, the CPU 403 determines whether or not color difference data of the processing result image data has undergone subsampling (thinning). Human vision is less sensitive to changes in color than changes in luminance. As such, a method that reduces the amount of data by subjecting the color data to subsampling is sometimes employed. For example, a pixel format in which the color difference data is subjected to subsampling that produces half the amount of data in the horizontal direction is called a “YcbCr 4:2:2” format. Additionally, a pixel format in which the color difference data is subjected to subsampling that produces half the amount of data in both the horizontal and vertical directions is called a “YcbCr 4:2:0” format. If the color difference data has been subjected to subsampling (YES in step S2002), the process moves to step S2003. If the color difference data has not been subjected to subsampling (NO in step S2002), the process moves to step S2004.

In step S2003, the CPU 403 upsamples the color difference data of the processing result image data. For example, if the pixel format of the processing result image data is the YcbCr 4:2:2 format, the color difference data is increased so that the amount of color difference data in the horizontal direction is doubled. Additionally, if the pixel format of the processing result image data is the YcbCr 4:2:0 format, the color difference data is increased so that the amount of color difference data in both the horizontal and vertical directions is doubled. The process then moves to step S2004.

In step S2004, the CPU 403 converts the format of the processing result image data from the luminance/color difference format into the RGB format. If the image data is image sequence data, information for converting the format of the processing result image data from the luminance/color difference format into the RGB format is stored in the color information box 1502 having a data type of “colr” (see FIG. 15). The color information box 1502 is included in the visual sample entry 1500, which itself is included in the sample description box 213. If the image data is image data, information for converting the format of the processing result image data from the luminance/color difference format into the RGB format is stored in the color information box 1903 included in the item property container box 1901. The process then moves to step S2005.

In step S2005, the CPU 403 displays the RGB data in the display unit 402.

In this manner, according to the present embodiment, a still image can be displayed properly using the still image file generated in any one of the first to fifth embodiments.

Variations

Although embodiments of the present disclosure have been described in detail above, the present disclosure is not intended to be limited to these embodiments, and various other embodiments within a scope that does not depart from the essential spirit of the present disclosure are also included in the present disclosure. For example, some of the aforementioned embodiments may be combined as appropriate.

Although the foregoing embodiments describe a case where the moving image file is a moving image file in the H.265/HEVC format as an example, the present disclosure is not limited thereto. For example, the moving image file may be a moving image file in the H.264/AVC format. The moving image file may also be a moving image file in the QuickTime file format.

Additionally, although a case where a plurality of frames (compressed frame data) for obtaining a still image are stored in HEIF file is described as an example, the present disclosure is not limited thereto. A plurality of frames for obtaining a still image may be stored in a file having a format in which a plurality of pieces of compressed frame data constituting a moving image are stored, and in which any one of the plurality of pieces of compressed frame data that are stored can be designated as a frame to be displayed.

Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-040125, filed Mar. 6, 2018, which is hereby incorporated by reference herein in its entirety.

What is claimed is:

1. An image processing apparatus comprising:
a selecting unit configured to select a particular frame among a plurality of frames encoded by using inter-frame-coding in a moving image file;
a specifying unit configured to specify one or more frames among the plurality of frames included in the moving image file, that is necessary for decoding the particular frame; and
a storing unit configured to store, in a still image file, the particular frame, the specified one or more frames and information indicating that the particular frame is to be displayed by decoding with the specified one or more frames.

2. The image processing apparatus according to claim 1, further comprising:
a determination unit configured to determine whether or not the particular frame can be decoded on its own, wherein the specifying unit specifies the one or more frames if the particular frame cannot be decoded on its own.

3. The image processing apparatus according to claim 1, further comprising:
a determination unit configured to determine whether or not the particular frame can be decoded on its own,
wherein the storing unit stores the particular frame in the still image file without the specifying unit specifying the one or more frames if the particular frame can be decoded on its own.

4. The image processing apparatus according to claim 1, further comprising:
a determination unit configured to determine whether or not all of the plurality of frames included in the moving image file can be decoded on their own,
wherein the storing unit stores the particular frame in the still image file without the specifying unit specifying the one or more frames if all of the plurality of frames included in the moving image file can be decoded on their own.

5. The image processing apparatus according to claim 1, further comprising:
a decoding unit configured to decode the particular frame; and
an encoding unit configured to encode the particular frame decoded by the decoding unit, in a format in which the particular frame can be decoded on its own,
wherein the storing unit further stores the particular frame encoded by the encoding unit in the still image file.

6. The image processing apparatus according to claim 1, wherein the selecting unit selects the particular frame in response to a user's operation, and wherein the specifying unit specifies the one or more frames automatically.

7. A control method of an image processing apparatus, the method comprising:
selecting a particular frame among a plurality of frames encoded by using inter-frame-coding in a moving image file;
specifying one or more frames among the plurality of frames included in the moving image file, that is necessary for decoding the particular frame; and
storing, in a still image file, the particular frame, the specified one or more frames and information indicating that the particular frame is to be displayed by decoding with the specified one or more frames.

8. A non-transitory computer-readable storage medium storing a program for causing a computer to execute the control method of an image processing apparatus, the method comprising:
selecting a particular frame among a plurality of frames encoded by using inter-frame-coding in a moving image file;
specifying one or more frames among the plurality of frames included in the moving image file, that is necessary for decoding the particular frame; and
storing, in a still image file, the particular frame, the specified one or more frames and information indicating that the particular frame is to be displayed by decoding with the specified one or more frames.
